(19) United States
(12) Patent Application Publication
(10) Pub. No.: US 2026/0002600 A1
(43) Pub. Date: Jan. 1, 2026

(54) FILL VALVE ACTUATION SYSTEMS AND METHODS

(71) Applicant: FLUIDMASTER, INC., San Juan Capistrano, CA (US)

(72) Inventors: Tuan Van Le, San Juan Capistrano, CA (US); Daniel McFarland, San Juan Capistrano, CA (US); Brendan Trang, San Juan Capistrano, CA (US); Joseph U. Han, San Juan Capistrano, CA (US); Gabriel Wong, San Juan Capistrano, CA (US)

(21) Appl. No.: 19/255,590

(22) Filed: Jun. 30, 2025

Related U.S. Application Data
(63) Continuation-in-part of application No. PCT/US23/86165, filed on Dec. 28, 2023.
(60) Provisional application No. 63/435,728, filed on Dec. 28, 2022.

(51) Int. Cl. F16K 21/18; F16K 31/26

(52) U.S. Cl. CPC F16K 21/18; F16K 31/26

(57) ABSTRACT

A fill valve system is disclosed for regulating fluid delivery into a tank or vessel using a combination of mechanical and hydraulic actuation. In some embodiments, the system includes a valve housing with a removable housing cap for internal access, a float arm pivotably coupled to the housing, and/or a float responsive to fluid level changes. In some embodiments, internal actuation components include a pin arm, arm linkage, poppet, diaphragm, and poppet pin. The diaphragm assembly regulates flow through a valve seat via pressure differentials created by a bleed hole mechanism. In some embodiments, a rotatable lock and stem coupling enable angular adjustment of the valve housing relative to an inlet stem, with discrete indexing positions for vertical alignment. In some embodiments, the system further includes a cleaning rotation feature to prevent mineral buildup. Various aspects of the systems and methods described herein are particularly suitable for low-pressure environments.

### CROSS-REFERENCE TO RELATED APPLICATION

This application is a Continuation-in-part application relating to and claiming the benefit of commonly-owned, co-pending PCT International Application No. PCT/US2023/086165, filed Dec. 28, 2023, which claims the benefit of priority from U.S. Provisional Patent Application No. 63/435,728, filed on Dec. 28, 2022, whereby the contents of which are incorporated herein in their entirety by reference.

### BACKGROUND

The present disclosure is directed to fill valves for fluid storage containers such as water towers, storage reservoirs, and toilet tanks, as non-limiting examples. The disclosure is not limited to any particular fluid or container configuration. Although the word water may be used to described functionality of a system, the word water is interchangeable with the word fluid for any embodiments described herein.

Fill valves in toilets provide water for refilling a toilet tank and for delivering fluid from the tank into the corresponding bowl during a flush cycle. Current fill valves typically use floats to sense water level to turn the water flow on and off. One problem with conventional designs is that a large amount of force is required to turn the fill valve on and off. As a result, the floats tend to be large and occupy a significant amount of space in the toilet tank. An example of this is the traditional piston and ballcock design which has a large float positioned on the end of a long lever arm. A long lever arm is required to generate enough force to overcome the hydraulic force through the fill valve in order to close the fill valve. A second problem with the fill valves of the prior art is that they tend to be noisy.

Another example of a traditional fill valve is a pilot valve. Pilot valves use a smaller float or activator to depressurize or pressurize a control chamber on top of a rubber diaphragm. Pilot valves, however, suffer from several shortcomings. For example, pilot valves are incapable of providing a sufficient fast flow rate at low pressures. Furthermore, pilot valves typically require tight tolerance parts to work properly.

Accordingly, a need exists for a fill valve which offers high flowrate at low pressures as seen in piston valves, and low activation force at high pressures as seen in pilot valves, to provide high flow rates with only small activation forces at high pressures to turn the fill valve on and off.

### SUMMARY

In some embodiments, the disclosure is directed to a fluid valve comprising one or more of an inlet conduit, a valve body, a diaphragm, a valve cap, a float, a float arm, and an outlet seat. In some embodiments, the diaphragm is coupled to the valve body. In some embodiments, a movement of the float arm in response to the float moving in a generally vertical direction is configured to cause the valve body to lift from the outlet seat. In some embodiments, the diaphragm is configured enable the valve body and the diaphragm to extend into an inner portion of the valve cap as a result of the movement of the float arm. In some embodiments, the diaphragm is secured in place between one or more diaphragm anchors and a cap wall. In some embodiments, the one or more diaphragm anchors extend from a top portion of the inlet conduit into the valve cap.

In some embodiments, the fluid valve further comprises a poppet. In some embodiments, the valve body includes a through-hole configured to enable the poppet to pass therethrough. In some embodiments, the poppet includes a hollow portion configured to equalize pressure between the inlet conduit and the back cavity portion defined by the valve cap and/or the inlet conduit. In some embodiments, the float arm is configured to engage a valve stem. In some embodiments, a movement of the float in a downward direction forces the valve stem up against the poppet.

In some embodiments, the valve cap comprises a piston guide. In some embodiments, the valve body includes a piston actuator. In some embodiments, the piston guide is configured to guide the valve body in a generally vertical direction into the valve cap using the piston actuator. In some embodiments, a top portion of the piston actuator is coupled to the float arm. In some embodiments, a downward motion of the float causes the float arm to pull the piston actuator up. In some embodiments, pulling the piston actuator upwards pulls the valve body away from the outlet seat.

In some embodiments, the disclosure is directed to a fluid valve comprising one or more of an inlet conduit, a valve body, a diaphragm, a valve cap, a float, a stem, a stem arm, a metering seal, one or more metering holes, and an outlet seat. In some embodiments, the valve cap is coupled to the inlet conduit. In some embodiments, the diaphragm is held in position by being trapped between the inlet conduit and the valve cap. In some embodiments, the diaphragm includes a plurality of metering holes that extend through the diaphragm parallel to the inlet conduit. In some embodiments, one or more metering holes are configured to enable fluid from the inlet conduit to bleed to a back cavity defined at least in part by the valve body and the valve cap.

In some embodiments, the valve cap is configured to couple to the metering seal. In some embodiments, a first portion of the stem is configured to seal a seal drain of the metering seal. In some embodiments, a second portion of the stem includes a reduced cross-section configured to enable fluid to leak past the seal drain. In some embodiments, a downward movement of the float causes the stem arm to pull the stem to a position where the reduced cross-section enables the fluid to leak past the stem through the seal drain. In some embodiments, the stem is configured to pull the valve body to an open in response to the float moving downward and/or push the valve body to a closed in response to the float moving upward. In some embodiments, the diaphragm is configured to enable fluid to pass through a relief gap between the valve cap and the inlet conduit in an area where the diaphragm is trapped in position in response to an increase inlet pressure.

In some embodiments, the disclosure is directed to a fluid valve comprising one or more of an inlet conduit, a valve body, a diaphragm, a valve cap, a float, a stem, a stem arm, a metering seal, a center metering hole, and an outlet seat. In some embodiments, the valve cap is coupled to the inlet conduit. In some embodiments, the diaphragm is held in position by being trapped between the inlet conduit and the valve cap. In some embodiments, the center metering hole is configured to enable fluid from the inlet to bleed through the valve body to a back cavity defined at least in part by the valve body and the valve cap. In some embodiments, the valve cap is configured to couple to the metering seal. In some embodiments, a portion of the stem is configured to seal a seal drain of the metering seal. In some embodiments, a portion of the stem includes a reduced cross-section configured to enable fluid to leak past the seal drain.

In some embodiments, a downward movement of the float caused the stem arm to pull the stem to a position where the reduced cross-section enables the fluid to leak past the stem through the seal drain. In some embodiments, the stem is configured to pull the valve body to an open in response to the float moving downward. In some embodiments, the stem is configured to push the valve body to a closed in response to the float moving upward. In some embodiments, the stem is configured to push the valve body to a closed position in response to the float moving upward. In some embodiments, the diaphragm is configured to enable fluid to pass through a gap between the valve cap and the inlet conduit in an area where the diaphragm is trapped in response to an increase inlet pressure.

Some embodiments of the disclosure are directed to providing an actuated fill valve with pilot technology that includes an ability to be opened and closed using an external force in conjunction with hydraulic forces flowing through the valve. Each of the actuated fill valves described herein provide better performance at low pressures as compared to conventional systems. The valves are used in applications where the range of operation pressures varies, but the required flow rates remain high.

In some embodiments, the actuated fill valve comprises a diaphragm that is preloaded by a compression spring to provide a positive shut off at low pressures. In some embodiments, in the shut off position, the pressures on both sides of the diaphragm are equal and/or up to about ten percent of being equal, where the net positive force to close the diaphragm on the sealing surface is a combination of the net hydraulic force on the diaphragm and the preload of the compression spring. In some embodiments, to open the valve, an external force such as a weight ballast from a float cup is configured to exert a side load to a poppet valve mounted on the center of the diaphragm, overcoming the spring force on the poppet to bleed pressure from the diaphragm, creating an imbalanced net hydraulic force on the diaphragm. In some embodiments, the weight from the float ballast along with the hydraulic force will continue to push the diaphragm to overcome the spring force and the resistance from fluid volume being metered by the orifice to open the valve.

In some embodiments, the fill valve system is configured to regulate fluid delivery into a tank or vessel through a combination of mechanical and hydraulic actuation. In some embodiments, a float arm is pivotably coupled to a housing cap and supports a float that rises and falls in response to fluid level changes. This movement actuates internal components within the valve housing, including a pin arm and arm linkage, to control the position of a poppet and diaphragm assembly, in accordance with some embodiments. In some embodiments, The outlet stem extends laterally from the valve housing and defines a flow path for fluid discharge.

During a flush cycle, in some embodiments, the float descends, causing the float arm to pivot downward. In some embodiments, this motion is transmitted through the arm linkage to the pin arm, which pivots and displaces the poppet pin vertically. In some embodiments, the poppet is unseated from the valve seat, allowing fluid to flow through the outlet. As the poppet pin moves, in some embodiments, the sealing end of the poppet disengages a bleed hole seal, enabling pressure to equalize across the diaphragm. This pressure differential lifts the diaphragm assembly, enhancing fluid flow responsiveness and maintaining high flow rates during actuation, in accordance with some embodiments.

As the tank refills, in some embodiments, the float ascends, reversing the motion of the float arm and pin arm. In some embodiments, the poppet pin is driven downward, resealing the bleed hole and allowing fluid to accumulate in the poppet cavity. This accumulation equalizes pressure on both sides of the diaphragm, maintaining the sealing engagement of the diaphragm and poppet against the valve seat, in accordance with some embodiments.

In some embodiments, the system includes a rotatable lock and stem coupling that allow for angular adjustment of the valve housing relative to the inlet stem. In some embodiments, the stem coupling features adjustment protrusions and recesses that provide discrete angular indexing positions. These features enable the valve housing to be rotated into a desired orientation and locked in place, ensuring vertical alignment of the outlet stem, in accordance with some embodiments.

In some embodiments, assembly of the inlet stem, stem coupling, and rotatable lock is achieved through a snap-fit installation. In some embodiments, the stem coupling is formed as a split collar that expands radially to fit over the inlet stem. In some embodiments, engagement between the adjustment protrusions and recesses resists inadvertent rotation and maintains alignment. In some embodiments, the system also includes a cleaning rotation feature that sweeps internal flow passages and seating surfaces, preventing buildup of mineral scale and debris. These features collectively contribute to stable, reliable operation and improved performance over conventional fill valve systems, in accordance with some embodiments.

### BRIEF DESCRIPTION OF DRAWINGS

FIG. 1 illustrates a section view of a hybrid pilot valve according to some embodiments.

FIG. 2 depicts the hybrid pilot valve of FIG. 1 in a closed position according to some embodiments.

FIG. 3 shows the hybrid pilot valve of FIG. 1 in an open position according to some embodiments.

FIG. 4 is a diagram of a balanced piston valve according to some embodiments.

FIG. 5 illustrates the balanced piston valve of FIG. 4 in a closed position according to some embodiments.

FIG. 6 illustrates the balanced piston valve of FIG. 4 in an open position according to some embodiments.

FIG. 7 shows a section view of an external metering stem shutoff fill valve according to some embodiments.

FIG. 8 demonstrates the external metering stem shutoff fill valve of FIG. 7 in an on position according to some embodiments.

FIG. 9 demonstrates the external metering stem shutoff fill valve of FIG. 7 in an off position according to some embodiments.

FIG. 10 depicts a section view of an internal metering stem shutoff valve according to some embodiments.

FIG. 11 illustrates a section view of an external metering push-pull loss motion fill valve according to some embodiments.

FIG. 12 portrays a section view of an internal metering push-pull loss motion fill valve according to some embodiments.

FIG. 13 displays a section view of an external metering push loss motion fill valve according to some embodiments.

FIG. 14 exhibits a section view of an internal metering push loss motion fill valve according to some embodiments.

FIG. 15 depicts a section view of an external metering pull loss motion fill valve according to some embodiments.

FIG. 16 demonstrates a section view of an internal metering pull loss motion fill valve according to some embodiments.

FIG. 17 shows a section view of a pressure relief seal according to some embodiments.

FIG. 18 illustrates the pressure relief seal from FIG. 17 in a closed position according to some embodiments.

FIG. 19 displays a section view of the pressure relief seal in FIG. 17 in a closed position according to some embodiments.

FIG. 20 portrays a section view of the pressure relief seal in FIG. 17 with a pressure relief path according to some embodiments.

FIG. 21 illustrates a fill valve system that is configured to regulate the delivery of fluid into a tank or vessel, in accordance with some embodiments.

FIG. 22 depicts a cross-sectional view of the fill valve system, in accordance with some embodiments.

FIG. 23 shows a cross-sectional view of internal actuation components of the fill valve system, in accordance with some embodiments.

FIG. 24 illustrates the fill valve system in a state of active fluid discharge during a flush cycle, in accordance with some embodiments.

FIG. 25 illustrates the fill valve system in a flush actuation state, in accordance with some embodiments.

FIG. 26 depicts fill actuation of a fill valve system, in accordance with some embodiments.

FIG. 27 illustrates the closing and sealing operation of the fill valve system, in accordance with some embodiments.

FIG. 28 shows a top view of the housing cap of the fill valve system, in accordance with some embodiments.

FIG. 29 shows a sectional view of the fill valve system showing an inlet axis offset from an outlet radial axis, in accordance with some embodiments.

FIG. 30 depicts an exploded view of the inlet stem assembly of the fill valve system, in accordance with some embodiments.

FIG. 31 illustrates a partial assembled sectional view focusing on the stem coupling, in accordance with some embodiments.

FIGS. 32 and 33 depict the assembly process of the inlet stem, stem coupling, and rotatable lock, in accordance with some embodiments.

FIG. 34 shows a cross-sectional view of the interface between the inlet stem and the stem coupling, in accordance with some embodiments.

FIG. 35 illustrates a cross-sectional view taken along line A-A of the assembled inlet stem and stem coupling, in accordance with some embodiments.

FIG. 36 depicts a vertically misaligned state of the fill valve system, in accordance with some embodiments.

FIG. 37 illustrates the fill valve system 100 in a vertically aligned configuration, in accordance with some embodiments.

### DETAILED DESCRIPTION

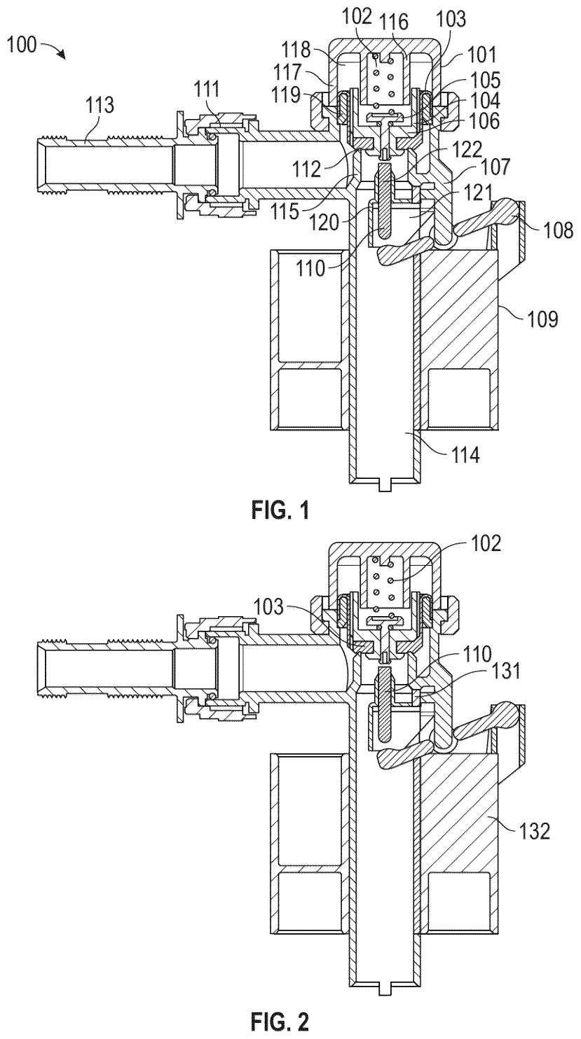

FIG. 1 illustrates a section view of a hybrid pilot valve according to some embodiments. In some embodiments, the hybrid pilot valve 100 comprises one or more of a cap 101, a compression spring 102, a rolling diaphragm 103, a valve body 104, a poppet 105, an O-ring 106, a valve body 107, an arm 108, a float 109, and a valve stem 110. Assuming a reference orientation for all embodiments described herein where the bottom of a cistern defines a horizontal surface, and the level of water in the cistern rises and falls in a vertical direction within the cistern, the hybrid pilot valve 100 fluid inlet 111 extends from the diaphragm seat 112 in a horizontal direction. In some embodiments, the hybrid pilot valve 100 is configured to attach to a horizontal fluid supply 113, where the float 109 is configured to move perpendicular relative to the inlet flow. In some embodiments, the inlet 111 extends to the diaphragm seat 112, where the seat wall 115 at least partially obstructs the horizontal flow of incoming fluid from the inlet 111. The incoming fluid is at least partially redirected by the seat wall 115 upwards toward the cap 101 and/or around the diaphragm seat 112 within the conduit body 107. Any directions described herein including, without limitation, “upward” and “downward,” include directions within ten percent of deviation from the specified direction.

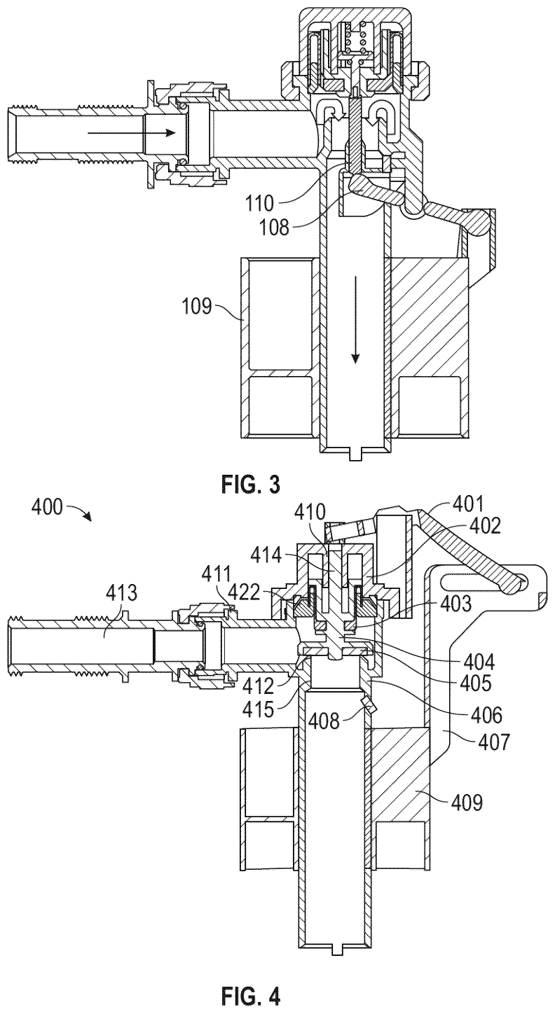

In some embodiments, the cap 101 is configured to couple to a top portion of the conduit body 107, where at least a portion of the cap 101 is positioned over the inlet 111 when assembled. In some embodiments, the cap 101 houses a compression spring 102 which is supported laterally by one or more spring walls 116 that substantially center the compression spring 102 within the cap 101. In some embodiments, the spring wall are configured to surround at least a portion of poppet 105 when the valve is an open position (see FIG. 3).

In some embodiments, the spring walls 116 and the cap walls 117 define a diaphragm chamber 118 configured to enable the rolling diaphragm 103 and/or the valve body 104 to extend vertically into the cap 101. In some embodiments, the rolling diaphragm 103 is secured in place between one or more diaphragm anchors 119 and the cap wall 117, where the one or more diaphragm anchors 119 extend from a top portion of the conduit body 107 into the cap 101. In some embodiments, a diaphragm anchor 119 comprises a continuous round shape. In some embodiments, the valve body 104 is substantially rigid and configured to couple to a portion of the rolling diaphragm 103, where the valve body 104 is configured to provide a downward force on the rolling diaphragm 103 against the diaphragm seat 122 via the compression spring 102.

In some embodiments, the rolling diaphragm 103 and/or the valve body 104 include a through-hole configured to enable the poppet 105 to pass therethrough. In some embodiments, the center hole and/or poppet 105 is aligned with a valve stem 110 positioned in the fluid outlet 114. In some embodiments, the valve stem 110 is secured in place by a stem housing 120, which includes a housing through-hole 122 substantially aligned with the poppet 105. The valve stem 110 is actuated by a first end of a float arm 108 which is pivotable attached to the conduit body 107. At least a portion of the stem housing 120 configured to surround at least a portion of the valve stem 110. Stem housing 120 includes a cavity 121 exposed to atmosphere which enables the float arm 108 to push the valve stem 110 against the poppet 105 without being directly exposed to fluid flowing in fluid outlet 114. In some embodiments, fluid flowing through the fluid outlet 114 flows around at least a portion of the stem housing 120, which defines the cavity. In some embodiments, a second end of the float arm 108 is coupled to a float 109, such that downward motion of the float 109 pulls the second end of the float arm 108 down while simultaneously pushing the first end up against the valve stem 110 when there is a drop in fluid level in the cistern. In some embodiments, the poppet 105 comprises a lateral hole and/or slit configured to allow fluid to pass to a through hole within the poppet valve while the valve stem 110 is in contact with the poppet 105. This allows equalization of fluid pressure above and below the valve body 104.

FIG. 2 depicts the hybrid pilot valve of FIG. 1 in a closed position according to some embodiments. In this position, the inlet 111 and at least part of the conduit body 107 is filled with fluid, while the fluid outlet is exposed to atmosphere. In some embodiments, the compression spring 102 is preloaded when the valve is in a closed state. In some embodiments, the preloaded compression spring 102 is configured to push the rolling diaphragm 103 down to close the valve even at low inlet pressures (e.g., 1-2 psi). The ability to maintain the valve in a closed position is important because in some countries low pressures are all that is available. In a closed position, the arm 108 is disengaged from the valve stem 110.

FIG. 3 shows the hybrid pilot valve of FIG. 1 in an open position according to some embodiments. As the float 109 lowers as a result of decreasing water level, arm 108 pivots upward to engage valve stem 110 and lift the rolling diaphragm 103 against the force of compression spring 102. The arrows represent the direction of fluid flow in the open position. Although a compression spring is described as a non-limiting illustration, other conventional biasing members including other types of springs and/or elastomers can also be used in some embodiments.

In some embodiments, the valve stem 110 enables the rolling diaphragm 103 to be lifted far enough to achieve a high flowrate even at low pressures. In some embodiments, a small portion of fill water is directed through ballast diverter 131 and into ballast chamber 132. The ballast chamber 132 collects the fill water which acts as a weight helping to pull the float 109 downward as the water level falls within a conventional fluid tank or cistern (not shown).

FIG. 4 is a diagram of a balanced piston valve 400 according to some embodiments. In some embodiments, the balanced piston valve 400 includes a top actuated fill valve that includes one or more of an arm 401, a cap 402, a rolling diaphragm 403, a piston 404, a piston seal 405, a valve body 406, a float 407, a ballast diverter 408, and a ballast chamber 409.

The balance piston valve 400 fluid inlet 411 extends from the diaphragm seat 412 to the fluid supply 413 in a horizontal direction. In some embodiments, balance piston valve 400 is configured to attach to a horizontal fluid supply 413, where the float 407 is configured to move perpendicular relative to the inlet flow. The inlet 411 extends to the diaphragm seat 412, where the seat wall 415 and/or piston 404 at least partially obstructs the horizontal flow of incoming fluid from the inlet 411. The incoming fluid is at least partially redirected by the seat wall 415 upwards toward the cap 402 and/or around the diaphragm seat 415 within the valve body 107.

In some embodiments, the cap 402 is configured to couple to the top of the valve body 406, where at least a portion of the cap 406 is positioned over the inlet conduit 411 when assembled. In some embodiments, the cap 402 comprises a piston guide 410 comprising one or more guide walls that substantially center the piston actuator 414 within the cap 402. In some embodiments, the piston guide 410 includes a through-hole configured to enable the piston actuator 414 to extend through the top of the cap 402 where a piston actuator top portion 416 is exposed to atmosphere. In some embodiments, a first end of float arm 401 is coupled to the piston actuator top portion 416 and a second end 418 of float arm 401 is coupled to the float 407. In some embodiments, the float 407 includes a vertically extending slot arm 419 comprising a horizontal slot 420. In some embodiments, the horizontal slot 420 is configured to guide the float arm second end 418 along a horizontal direction while the float 407 moves in a vertical direction.

In some embodiments, the cap walls 421 define a diaphragm chamber 118 configured to enable the rolling diaphragm 403 and/or at least a portion of the piston 404 to extend vertically into the cap 402 as the valve is opened. In some embodiments, the rolling diaphragm 403 is secured in place between one or more diaphragm anchors 422 and the cap wall 421, where the one or more diaphragm anchors 422 extend from a top portion of the valve body 107 toward the piston 404. In some embodiments, one or more diaphragm anchors comprise a continuous round shape. In some embodiments, the rolling diaphragm 403 is configured to substantially seal an upper portion of the cap 402 and/or piston guide 410 from fluid during operation.

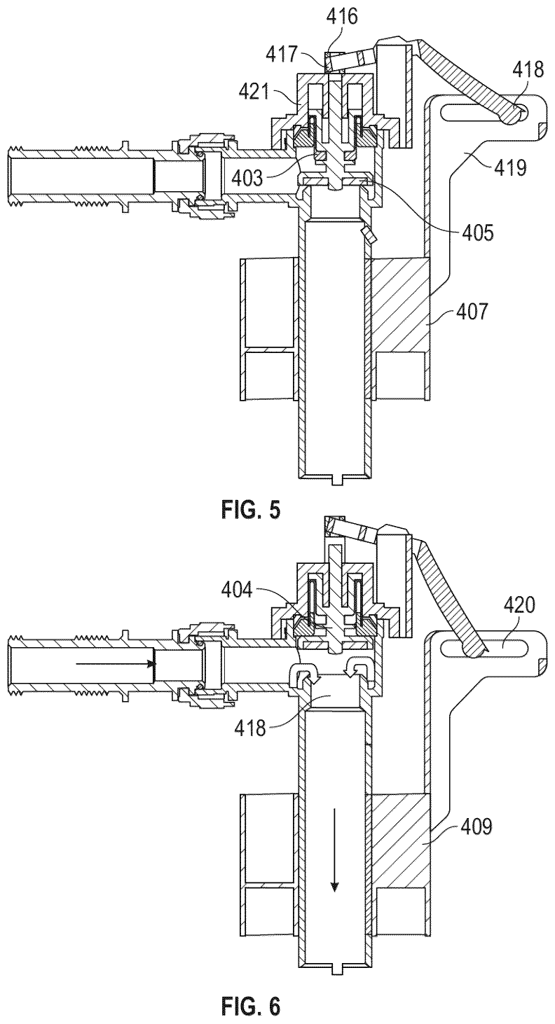

FIG. 5 illustrates the balanced piston valve of FIG. 4 in a closed position according to some embodiments. In some embodiments, the effective area on the rolling diaphragm 403 and the piston seal 405 are each designed to balance each other using (low; less than 50 psi) inlet pressure. In some embodiments, the net force on the piston 403 in the closed position under any inlet pressure is very small (e.g., less than 1 psi). In some embodiments, the small piston net force requires less buoyant force on the float 407 to overcome, compared to a conventional ballcock design. In some embodiments, a small portion of fill water is directed through ballast diverter 408 and into ballast chamber 409. The ballast chamber 409 collects the fill water which acts as a weight helping to pull the float 407 downward as the water level falls within a conventional tank (not shown), ensuring maximum flowrate.

FIG. 6 illustrates the balanced piston valve of FIG. 4 in an open position according to some embodiments. In some embodiments, as the float 407 moves down, the piston 404 is raised to allow fluid to flow through the valve outlet 418 (as shown by arrows). In some embodiments, fill water that has collected in ballast chamber 409 during one or more subsequent flushes is configured to pull the piston 404 to partially or a fully open position allowing for high flowrates (greater than 10 gpm) at both high (greater than 50 psi) and low (0.1-50 psi) pressures.

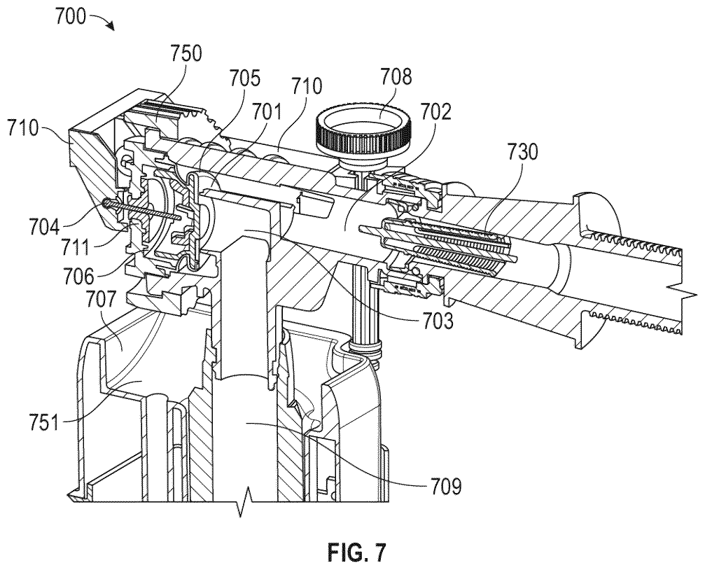

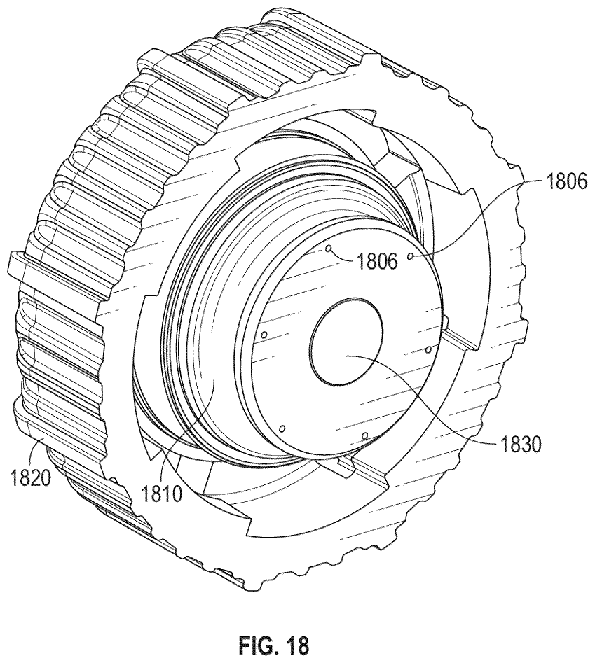

FIG. 7 shows a section view of an external metering stem shutoff fill valve 700 according to some embodiments. In some embodiments, the external metering shutoff fill valve 700 comprises one or more of a diaphragm 701, an inlet conduit 702, an outlet conduit 703, a stem 704, one or more metering holes 705, a back cavity 706, a float 707, a screw 708, a downtube 709, a metering seal 711, and a stem arm 710. In some embodiments, the diaphragm 701 comprises one or more metering holes 705 on the exterior directly in the path of the inlet conduit 702 that allow water to flow through the diaphragm 701 into the back cavity 706. FIG. 18 shows a close-up view of metering hole positions 1806 for valves in FIGS. 5, 11, 13, 15, and 17.

Referring back to FIG. 7, in some embodiments, the external metering stem shutoff fill valve 700 includes an inlet conduit 702 comprising at least one in-line filter 730. In some embodiments, the flow of incoming water is perpendicular to the travel of the float 707. In some embodiments, the level in the tank where fluid valve 700 is installed is controlled by screw 708 which raises and lowers the float in a vertical direction, changing the level at which the stem arm 710 actuates the stem 704. In some embodiments, the diaphragm 701 is configured to engage the outlet seat 731 when the stem arm 710 is at its highest position. In some embodiments, stem 704 includes a fluted section 732, which includes a reduced cross-section configured to enable fluid to drain from back cavity 706 through the seal drain 733. In some embodiments, the draining of fluid from the back cavity 706 causes the pressure to drop below inlet pressure such that the inlet fluid pressure pushes the diaphragm 701 and valve body 740 away from the outlet seat 731. In some embodiments, in an unactuated state, a sealing cross-section 734 of stem 704 engages the walls of seal drain 733 allowing fluid to enter the back cavity 706 via metering holes 705. Because the surface area of the valve body 740 in the back cavity 706 is greater than the surface area of the diaphragm 701 front face the diaphragm 701 reseats against outlet seat 731 in some embodiments.

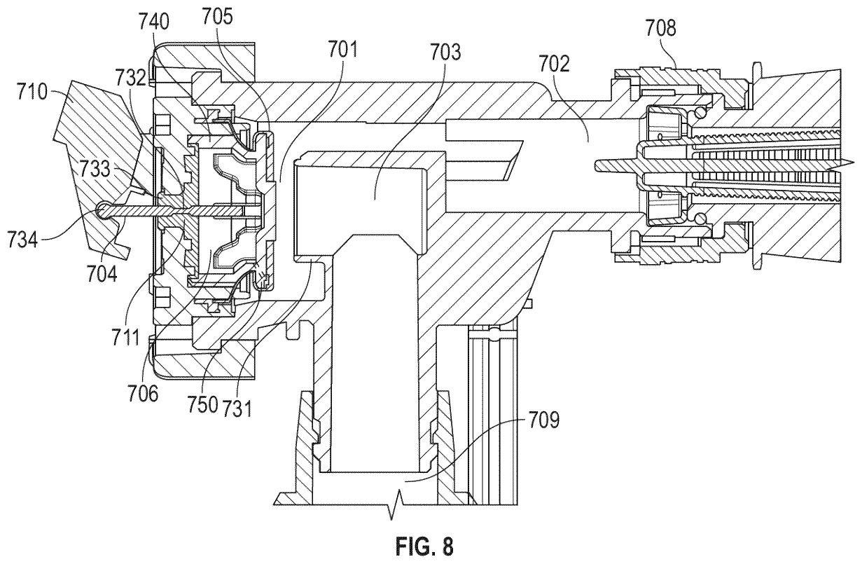

FIG. 8 demonstrates the external metering stem shutoff fill valve of FIG. 7 in an “on” position according to some embodiments. As shown in FIG. 8, as the tank level drops a float 707 attached to the float adjustment screw 708 moves vertically along the bearing surface of the downtube 709. In some embodiments, the arm 710, connected to the screw 708 and the stem 704 translates this vertical motion into horizontal motion of the stem 704. In some embodiments, the “on” position is determined by the float 707 being at a “low” position, which retracts the stem 704 and unseals the stem surface against the metering seal 711. In this actuated position, the fluted section 732 of the stem 704 has been pulled by stem arm 710 such that the reduced cross-section allows fluid to drain through seal drain 733. In this position, the valve body 740 is configured to enable fluid from fluid inlet 702 to flow past outlet seat 731, which is perpendicular to incoming flow in some embodiments. In this configuration, metering holes 705 allow fluid to pass through the diaphragm 701. In some embodiments, the incoming fluid flows through metering holes 705 and between the valve body 740, the diaphragm 701, the cap 750, and/or through the valve body 740 through metering conduit 750, both of which are shown in FIG. 8. In some embodiments, the float 707 comprises a fluid trap 751 configured to capture at least a portion of the fluid leaking through seal drain 733. In some embodiments, the float 707 is configured to retain at least a portion of the fluid from the fluid trap 751 to aid the float 707 moving in the vertical direction.

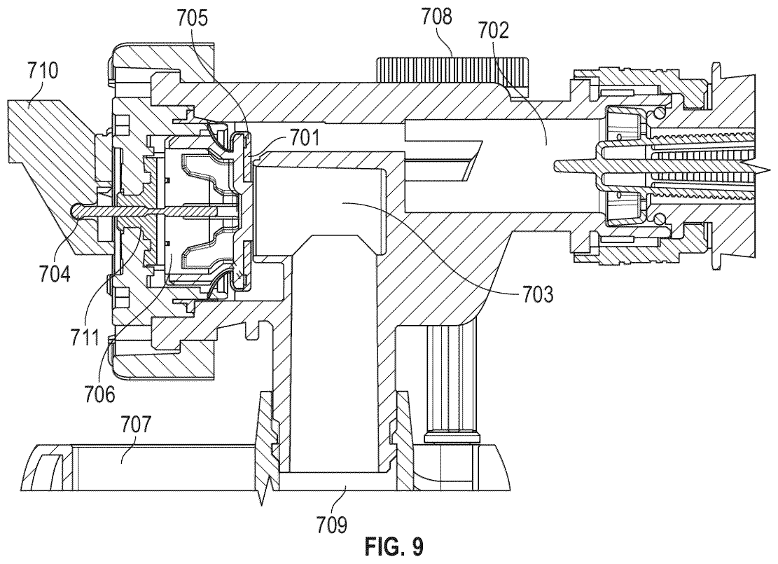

FIG. 9 demonstrates the external metering stem shutoff fill valve of FIG. 7 in an “off” position according to some embodiments. In some embodiments, as water level within a conventional tank (not shown) rises, the float 707, attached to the screw 708, moves vertically along the bearing surface of the downtube 709. In some embodiments, the arm 710 is connected to the screw 708 and the stem 704 translates this vertical motion into horizontal motion of the stem 704. In some embodiments, the “off” position is determined by the float 707 being at a “highest” position, in which the stem 704 seals the seal drain in the back cavity 706, allowing the pressure to equalize across the inlet 702 and the back cavity 706 via fluid entering through the one or more metering holes 705. In some embodiments, the larger surface area of the back cavity 706 forces the seal 705 to fully close against the outlet 703.

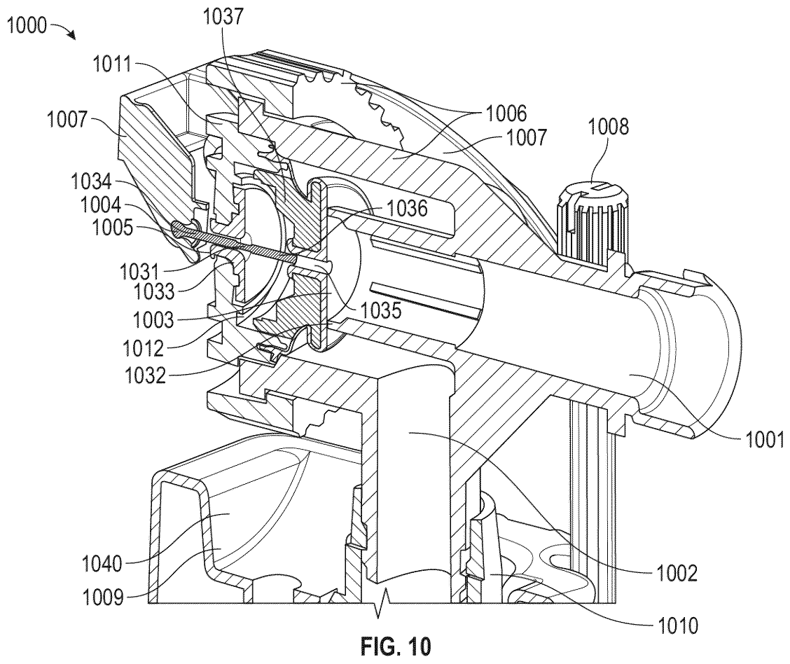

FIG. 10 depicts a section view of an internal metering stem shutoff valve 1000 according to some embodiments. In some embodiments, the internal metering stem shutoff fill valve comprises one or more of an inlet conduit 1001, an outlet tube 1002, a diaphragm 1003, a stem 1004, a metering seal 1005, a diaphragm inlet 1006, an arm 1007, a screw 1008, a float 1009, a downtube 1010, a metering hole 1011, and a back cavity 1012. In some embodiments, the inlet conduit 1001 is configured to enable fluid to flow through the center of the outlet tube 1002 and activates the diaphragm 1003 by flexing the diaphragm 1003 and uncovering the outlet 1002. In some embodiments, the diaphragm 1003 comprises a metering hole 1011 in the interior directly in the path of the inlet 1001 that allows water to flow through the diaphragm 1003 into a back cavity 1012.

Still referring to FIG. 10, in some embodiments, the internal metering stem shutoff valve 1000 is similar to the external metering stem shutoff fill valve 700 in that it includes an inlet comprising at least one in-line filter, which is not shown as the inlet connections and structure are similar in each of the valves depicted in FIGS. 5, 11, 13, 15, and 17. Written description of similar structures between these figures recited in association with a particular embodiment may be used when defining the metes and bounds of some embodiments without departing from the scope of the disclosure. In some embodiments, the flow of incoming water is perpendicular to the travel of the float 1009. In some embodiments, the level in the tank where valve 1000 is installed is controlled by screw 1008 which raises and lowers the float 1009 in a vertical direction, changing the level at which the stem arm 1007 actuates the stem 1007, which is also similar to the valves depicted in FIGS. 5, 11, 13, 15, and 17. In some embodiments, the diaphragm 1003 is configured to engage the outlet seat 1032 when the stem arm 1007 is at its highest position. In some embodiments, stem 1004 includes a fluted section 1031, which includes a reduced cross-section configured to enable fluid to drain from back cavity 1012 through the seal drain 1033. The draining of fluid from the back cavity 1012 causes the pressure to drop below inlet pressure such that the inlet fluid pressure pushes the diaphragm 1003 away from the outlet seat 1032. In an unactuated state, a sealing cross-section 1034 of stem 1004 engages the walls of seal drain 1033 allowing fluid to enter the back cavity 1012 via a single center metering hole 1035. Because the surface area of the valve body 1037 in the back cavity 1012 is greater than the surface area of the diaphragm 701 the valve reseats against outlet seat 1032.

In some embodiments, the “on” position is determined by the float 1009 being at a “low” position, retracting the stem 1004 and unsealing the stem surface against the metering seal 1005. In this actuated position, the fluted section 1031 of the stem 1004 has been pulled by stem arm 1007 such that the reduced cross-section allows fluid to drain through seal drain 1033. In addition, the center seal 1036 portion of the stem 1004 is withdrawn from the center metering hole 1035 to a distance where fluid flows freely into the back cavity 1012. In some embodiments, the center seal 1036 portion is completely withdrawn from the center metering hole 1035 in the “on” position. In this position, the valve body 1037 is configured to enable fluid from inlet conduit 1001 to flow past outlet seat 1032, which is perpendicular to incoming flow. In this configuration, the center metering hole 1035 allows fluid to pass through the diaphragm 1003. In some embodiments, the float 1009 comprises a fluid trap 1040 configured to capture at least a portion of the fluid leaking through seal drain 1033. In some embodiments, the float 1009 is configured to retain at least a portion of the fluid from the fluid trap 1040 to aid the float 1009 movement in the vertical direction.

In some embodiments, the “off” position is determined by the float 1009 being at a “high” position, in which the stem 1004 seals the back cavity 1012, allowing the pressure to equalize across the inlet 1001 and the back cavity 1012. In some embodiments, the larger surface area of the back cavity 1012 causes the diaphragm 1003 to close against the outlet 1002. In some embodiments, as water level rises within a conventional tank (not shown), the float 1009, which is attached to the screw 1008, moves vertically along the bearing surface of the downtube 1010 and the arm 1007, connected to the screw 1008 and the stem 1004, and translates this vertical motion of the float 1009 into horizontal motion of the stem 1004.

While the float rises the stem 1004 is forced forward along the first distance sealing the metering drain 1005 before the center metering hole 1035 is sealed by the center seal 1036. This enables time for fluid pressure to equalize on both sides of valve body 1037 before the center metering hole 1035 is sealed from incoming fluid when the stem lever 1007 is at its highest point. In some embodiments, the center metering hole 1035 is configured and/or sized to enable the diaphragm 1003 to seat against the outlet seat 1032 before the center seal 1036 portion of the stem 1004 seals the center metering hole 1035. In some embodiments, the stem 1004 is configured such that the center seal 1036 portion does not seal the center metering hole 1035 when the reduced cross section is positioned to allow fluid to bleed through the seal drain 1033 and the valve body 1037 is retracted to a fully open position.

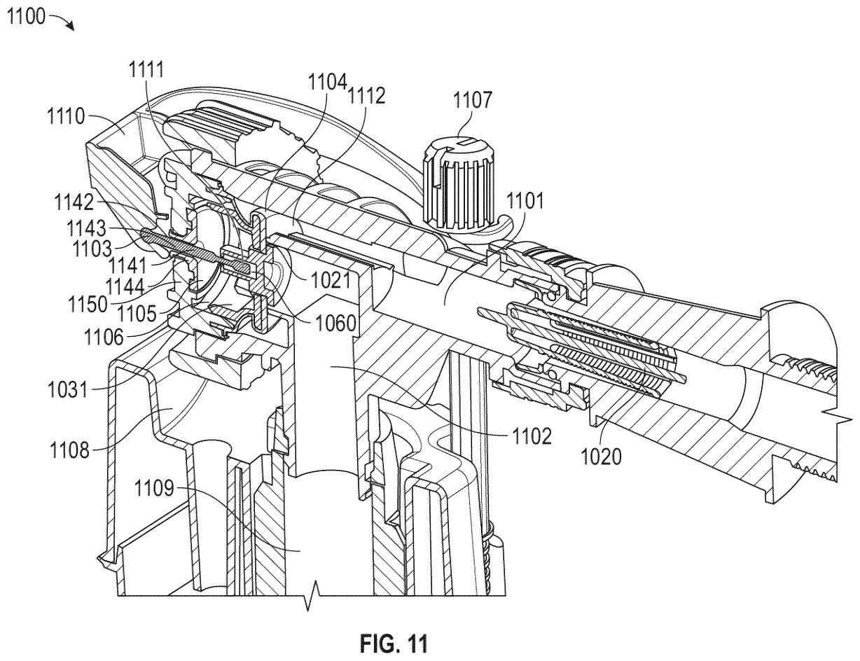

FIG. 11 illustrates a section view of an external metering push-pull loss motion fill valve 1100 according to some embodiments. In some embodiments, the external metering push-pull loss motion fill valve 1100 comprises one or more of an inlet conduit 1101, an outlet conduit 1102, a loss-motion stem 1103, one or more metering holes 1104, a metering seal 1105, a back cavity 1106, a screw 1107, a float 1108, a downtube 1109, an arm 1110, a knuckle 1111, and a diaphragm 1112.

The external metering push-pull loss motion fill valve 1100 is substantially similar in design and function as the external metering stem shutoff fill valve 700 (metering holes, float, etc.) with the exception of the loss-motion stem 1103 and part of the valve body 1031. In some embodiments, the external metering push-pull loss motion fill valve 1100 includes an inlet conduit 1101 comprising at least one in-line filter 1020. In some embodiments, the flow of incoming water is perpendicular to the travel of the float 1108. The level in the tank where fluid valve 1100 is installed is controlled by screw 1107 which raises and lowers the float in a vertical direction, changing the level at which the stem arm 1110 actuates the stem 1103. In some embodiments, the diaphragm 1112 is configured to engage the outlet seat 1021 when the stem lever 1110 is at its highest position.

In some embodiments, stem 1103 includes a fluted section 1141, which includes a reduced cross-section configured to enable fluid to drain from back cavity 1106 through the seal drain 1142. The draining of fluid from the back cavity 1106 causes the pressure to drop below inlet pressure such that the inlet fluid pressure pushes the diaphragm 1112 away from the outlet seat 1021. In an unactuated state, a sealing cross-section 1143 of stem 1103 engages the walls of seal drain 1144 allowing fluid to pressurize the back cavity 1106 via metering holes 1104. The incoming fluid flows through metering holes 1104 and between the valve body 1031 and the cap 1150, and/or through the valve body through a metering conduit (not shown), both of which are best shown in FIG. 7 but are present in this and other similar embodiments. In some embodiments, because the surface area of the valve body 1031 in the back cavity 1106 is greater than the surface area of the diaphragm 1112 front face, the valve reseats against outlet seat 1021.

In some embodiments, the valve body 1031 includes a push-pull cavity 1060 configured to house a front portion of stem 1003. In some embodiments, the front portion includes a reduced cross-section and/or one or more expanded cross-sections configured to trap the front portion within the push-pull cavity 1060. The area of transition from an area of reduced cross-section to greater cross-section are referred to as transition zones herein according to some embodiments.

In some embodiments, the water inlet 1101 flows through the outlet tube 1102 and activates the diaphragm 1112 by flexing the diaphragm 1112 in a reward motion uncovering the outlet 1102. In some embodiments, the diaphragm 1112 is connected to the loss-motion stem 1103 that pushes and pulls the diaphragm 1112 during the opening and closing phase. In some embodiments, as the float 1108 moves down the fluted section 1144 allows pressure to bleed from the back cavity 1106 unseating the diaphragm 1112. In some embodiments, as the stem arm 1110 continues to pull the loss-motion stem 1103, a front transition zone of the stem engages the rear through-wall of the push-pull cavity 1060 pulling the valve open with mechanical force, ensuring the valve fully opens. In some embodiments, as the stem 1103 is moved forward by the stem lever 1110 as the float 1108 rises, the seal drain 1142 is sealed by the sealing cross-section 1143 which allows pressure in the back cavity 1106 to equalize as previously described with reference to FIG. 7. In addition, in some embodiments, as the stem 1103 moves forward, a rear transition zone of the loss-motion stem 1103 engages an outside portion of the rear through-wall pushing the valve body 1031 forward with mechanical force.

In some embodiments, the diaphragm 1112 comprises one or more metering holes 1104 on the outer parameter of diaphragm 1112 which puts the one or more metering holes 1104 directly in the path of the inlet 1101, allowing water to flow through the diaphragm 1112 into the back cavity 1106. In some embodiments, the one or more metering holes described herein are open toward the inlet 1101.

In some embodiments, as water level within a conventional fluid tank (not shown) rises, the float 1108, connected to the screw 1107 moves vertically along the bearing surface of the downtube 1109 and the arm 1110, connected to the screw 1107 and the stem 1103, translates this vertical motion of the float 1108 into horizontal motion of the stem 1103. In some embodiments, the “on” position is determined by the float 1108 being at a “low” position, retracting the stem 1103 and unsealing the stem surface against the metering seal 1105. In some embodiments, the initial actuation of the stem arm 1110 breaks the metering seal 1105 and the stem seal releases pressure from the back cavity 1106. In some embodiments, the transition zone includes a knuckle 1111, which includes an expanded portion of the stem cross-section as previously described. In some embodiments, as the arm 1110 travels, the knuckle 1111 captures the seal 1112 and mechanically opens the diaphragm 1112 further creating a larger water flow path. In some embodiments, the “off” position is determined by the float 1108 being at a “high” position, actuating the stem 1103. In some embodiments, in the “off” position the stem 1103 seals the back cavity 1106, allowing the pressure to equalize across the inlet 1101 and the back cavity 1106 during initial actuation. In some embodiments, as the stem 1103 continues to move, the stem 1103 recaptures the diaphragm 1112 and mechanically pushes the diaphragm 1112 closer. In some embodiments, the larger surface area of the back cavity 1106 forces the diaphragm 1112 to fully close against the outlet 1102.

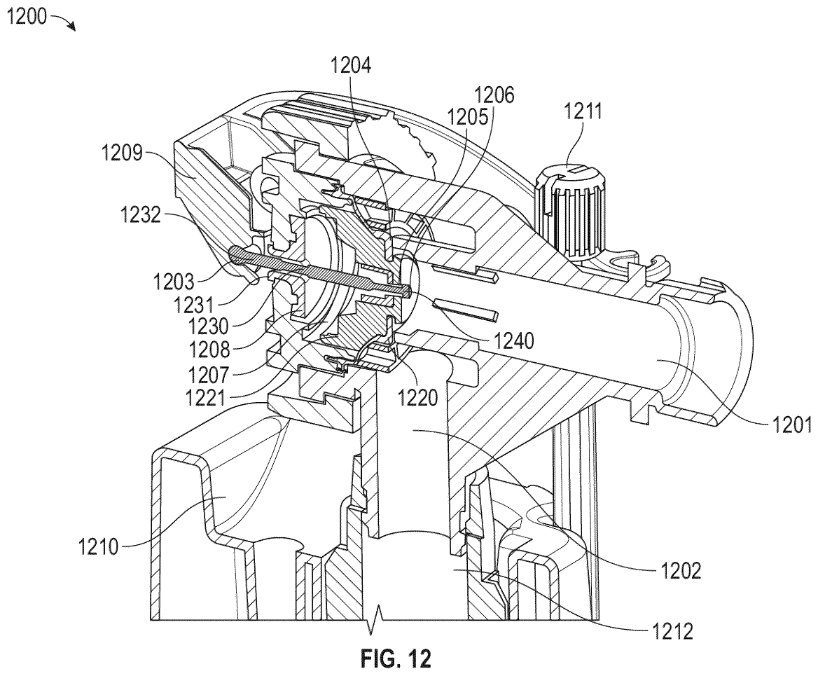

FIG. 12 portrays a section view of an internal metering push-pull loss motion fill valve 1200 according to some embodiments. In some embodiments, the internal metering push-pull loss motion fill valve 1200 comprises one or more of an inlet conduit 1201, an outlet tube 1202, a loss-motion stem 1203, a diaphragm 1204, a center metering hole 1205, a knuckle 1206, a back cavity 1207, a metering seal 1208, a stem arm 1209, a float 1210, a screw 1211, and a downtube 1212. Similar to other embodiments as mentioned above, the internal metering push-pull loss motion fill valve 1200 includes an inlet conduit 1201 comprising at least one in-line filter (not shown). In some embodiments, the flow of incoming water is perpendicular to the travel of the float 1210. In some embodiments, the level in the tank where fluid valve 1200 is installed is controlled by screw 1211 which raises and lowers the float in a vertical direction, changing the level at which the stem arm 1209 actuates the stem 1203. In some embodiments, the diaphragm 1204 is configured to engage the outlet seat 1220 when the stem lever 1209 is at its highest position. In some embodiments, stem 1203 includes a fluted section 1230, which includes a reduced cross-section configured to enable fluid to drain from back cavity 1207 through the seal drain 1231. The draining of fluid from the back cavity 1207 causes the pressure to drop below inlet pressure such that the inlet fluid pressure pushes the diaphragm 1204 away from the outlet seat 1220. In an unactuated state, a sealing cross-section 1232 of stem 1203 engages the walls of seal drain 1231 allowing fluid to enter the back cavity 1207 via a center metering hole 1205. Because the surface area of the valve body 1221 in the back cavity 1207 is greater than the surface area of the diaphragm 1204 the valve reseats against outlet seat 1220.

In some embodiments, the valve body 1221 includes a center metering hole 1205 configured to enable pressure to equalize between the inlet conduit 1201 and the back cavity 1207. In some embodiments, the center metering hole 1205 is configured to trap a front fluted section 1240 of the stem 1203 therebetween. In some embodiments, as the stem arm 1209 continues to pull the stem 1203, a front transition zone of the fluted section 1240 engages a front of the valve body 1221 pulling the valve open with mechanical force, ensuring the fluid valve 1200 fully opens. In some embodiments, as the stem 1203 is moved forward by the stem arm 1209 as the float 1210 rises, the seal drain 1231 is sealed by the sealing cross-section 1232 which allows pressure in the back cavity 1207 to equalize through the center metering hole 1205, where fluid flows between the fluted section 1240 and the valve body 1221. In addition, in some embodiments, as the stem 1203 moves forward, a rear transition zone of the fluted section 1240 engages an inner valve wall pushing the valve body 1221 forward with mechanical force. In some embodiments, the mechanical pushing and/or pulling of the stem 1203 (or any stem described herein) reduce or eliminates the likelihood of the valve being stuck in the open or closed position.

Under normal operating conditions water flows through inlet 1201 and activates the diaphragm 1204 by providing the force need to flex the diaphragm 1204 diaphragm. and uncover the outlet 1202. In some embodiments, the diaphragm 1204 is connected to the loss-motion stem 1203 that pushes and pulls the diaphragm 1204 during the opening and closing phase. As previously described the diaphragm 1204 includes a center metering hole 1205 on the interior directly in the path of the inlet 1201 that allows water to flow through the valve body 1221 into the back cavity 1207 when the float 1210 drops. In some embodiments, as water level within a conventional tank (not shown) rises, the float 1210, connected to the screw 1211, moves vertically along the bearing surface of the downtube 1212 and the arm 1209, connected to the screw 1211 and the stem 1203, and translates this vertical motion of the float 1210 into horizontal motion of the stem 1203.

In some embodiments, the “on” position is determined by the float 1210 being at a “low” position, retracting the stem 1203 and unsealing the stem surface against the metering seal 1208. In some embodiments, during the opening phase of the “on” position, the initial actuation of the loss-motion stem 1203 breaks the seal, releasing pressure of the back cavity 1207 through metering seal 208. In some embodiments described herein, the transition zone of a fluted section comprises a knuckle. In some embodiments, as the stem 1203 continues to travel, the knuckle 1206 captures the seal 1204 and the actuation mechanically opens the seal 1204 further, creating a larger water flow path. In some embodiments, the “off” position is determined by the float 1210 being at a “high” position, actuating the stem 1203. In some embodiments, during the “off” position, the stem 1203 seals against the metering seal 1208, sealing the back cavity 1207 and allowing the pressure to equalize across the inlet 1201 and the back cavity 1207 during initial actuation. In some embodiments, as the arm 1209 continues to move, a rear transition zone on the fluted section 1240 captures the seal 1204 once again and mechanically pushes the seal closer to the “off” position. In some embodiments, the larger surface area of the back cavity 1207 causes the seal to fully close against the outlet 1202.

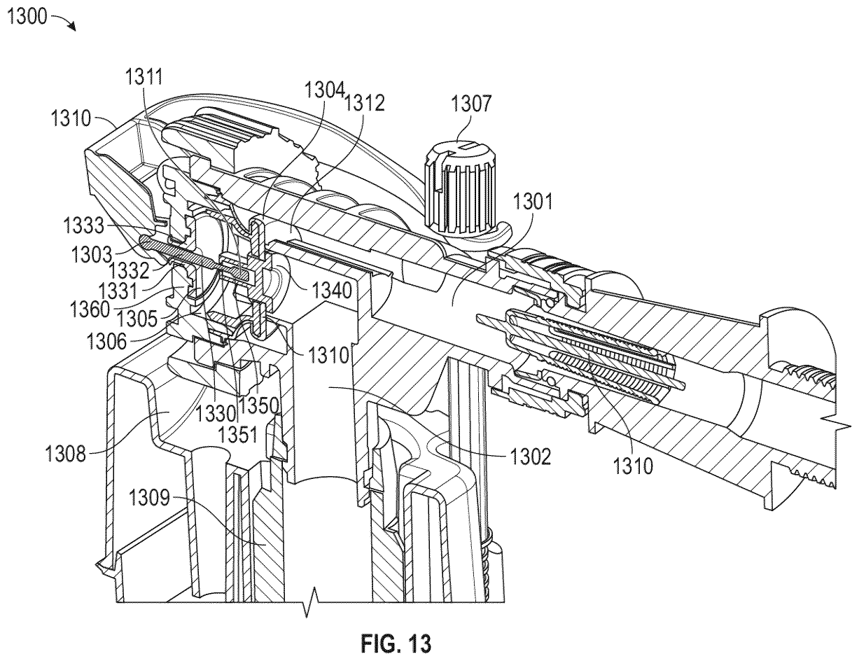

FIG. 13 displays a section view of an external metering push loss motion fill valve according to some embodiments. In some embodiments, the external metering push loss motion fill valve comprises one or more of a fluid inlet conduit 1301, an outlet tube 1302, a loss-motion stem 1303, one or more metering holes 1304, a metering seal 1305, a back cavity 1306, a screw 1307, a float 1308, a float 1308, a downtube 1309, an arm 1310, a knuckle 1311, and a diaphragm 1312.

In some embodiments, the external metering push loss motion fill valve 1300 is substantially similar to the external metering push-pull loss motion fill valve 1100 shown in FIG. 11 with the exception of the stem 1303. In some embodiments, the external metering push loss motion fill valve 1300 includes an inlet conduit 1301 comprising at least one in-line filter 1310. In some embodiments, the flow of incoming water is perpendicular to the travel of the float 1308. In some embodiments, the level in the tank where fluid valve 1300 is installed is controlled by screw 1307 which raises and lowers the float in a vertical direction, changing the level at which the stem arm 1310 actuates the stem 1303. In some embodiments, the diaphragm 1312 is configured to engage the outlet seat 1320 when the stem lever 1310 is at its highest position.

In some embodiments, stem 1303 includes a fluted section 1330, which includes a reduced cross-section configured to enable fluid to drain from back cavity 1306 through the seal drain 1331. In some embodiments, the draining of fluid from the back cavity 1306 causes the pressure to drop below inlet pressure such that the inlet fluid pressure pushes the diaphragm 1312 away from the outlet seat 1310. In some embodiments, in an unactuated state, a sealing cross-section 1332 of stem 1303 engages the walls of seal drain 1331 allowing fluid to pressurize the back cavity 1306 via metering holes 1304. In some embodiments, because the surface area of the valve body 1340 in the back cavity 1306 is greater than the surface area of the a front face of the diaphragm 1312 and/or exposed valve body 1340 the valve reseats against outlet seat 1310.

In some embodiments, the valve body 1340 includes a push cavity 1350 configured to house a front portion of stem 1303. In some embodiments, the front portion includes a reduced cross-section 1351 and/or one or more expanded cross-sections 1311 configured to trap the front portion within the push cavity 1350.

In some embodiments, the water inlet 1301 is configured to enable fluid to flow around the exterior entrance of the outlet tube 1302 and activate the diaphragm 1312 by flexing the diaphragm 1312 and uncovering the outlet 1302. In some embodiments, the diaphragm 1312 is connected to the loss-motion stem 1303 that pushes the seal 1312 during the closing phase of the valve shutoff. In some embodiments, as the float 1308 moves down the fluted section 1331 allows pressure to bleed from the back cavity 1306 unseating the diaphragm 1312. The difference between FIG. 13 and FIG. 11 is the stem 1303 is configured such that as the stem arm 1310 continues to pull the loss-motion stem 1303 rearward, the front transition zone does not engage the rear through-wall of the push cavity 1350, which results in no mechanical force applied during opening. In some embodiments, as the stem 1303 is moved forward by the stem lever 1310 as the float 1308 rises, the seal drain 1333 is sealed by the sealing cross-section 1332 which allows pressure in the back cavity 1306 to equalize as previously described with reference to FIG. 11. Similar to FIG. 11, in some embodiments, as the stem 1303 moves forward, a rear transition zone of the loss-motion stem 1303 engages an outside portion of the rear through-wall pushing the valve body forward with mechanical force.

In some embodiments, the seal 1312 comprises one or more metering holes 1304 on the exterior directly in the path of the inlet 1301 that allows water to leak through the seal 1312 into the back cavity 1306. In some embodiments, the incoming fluid flows through metering holes 1304 and between the valve body 1340 and the cap 1360, and/or through the valve body 1340 through a metering conduit (not shown), both of which are best shown in FIG. 7 but are present in this and other embodiments. In some embodiments, with the metering seal 1305 sealed, pressure within the back cavity 1306 equalizes to the inlet pressure. In some embodiments, the larger surface area of the valve in the cavity relative to the portion exposed to the incoming fluid causes the valve to seat sealing the outlet tube 1302.

In some embodiments, as the water level within a conventional tank (not shown) rises, the float 1308, connected to the screw 1307, moves vertically along the bearing surface of the downtube 1309 and the arm 1310, which are connected to the screw 1307 and the stem 1303, and translates this vertical motion of the float 1308 into horizontal motion of the stem 1303. In some embodiments, the “on” position is determined by the float 1308 being at a “low” position, retracting the stem 1303 and unsealing the stem surface against the metering seal 1305. In some embodiments, the “off” position is determined by the float 1308 being at a “high” position, actuating the stem 1303. In some embodiments, in the “off” position the stem 1303 seals the back cavity 1306, allowing the pressure to equalize across the inlet 1301 and the back cavity 1306. In some embodiments, as the stem 1303 moves, the stem 1303 captures the seal 1312 and mechanically pushes the seal 1312 closer to the “off” position. In some embodiments, the larger surface area of the back cavity 1306 forces the seal 1312 to fully close against the outlet 1302 when the pressure is equalized.

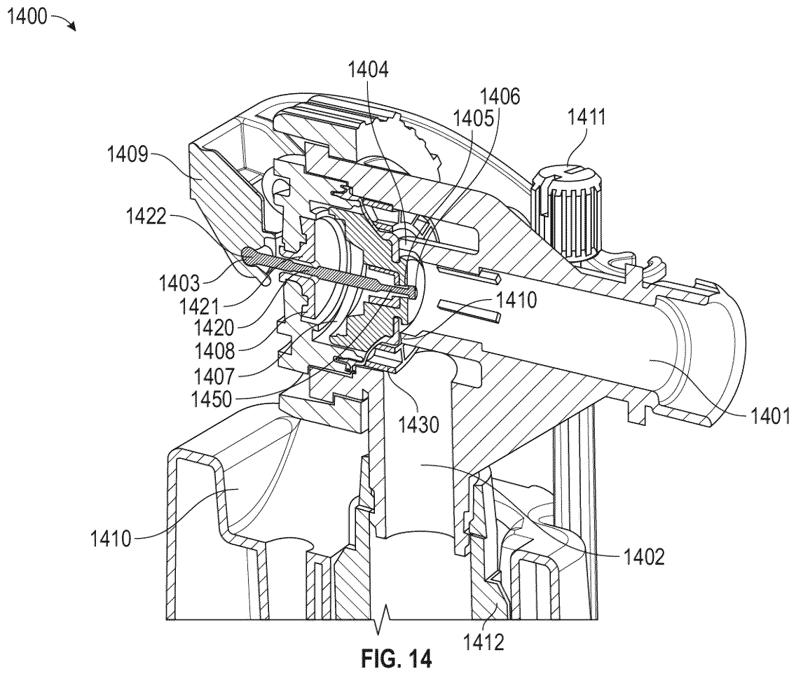

FIG. 14 exhibits a section view of an internal metering push loss motion fill valve 1400 according to some embodiments. In some embodiments, the internal metering push loss motion fill valve 1400 is substantially similar to the internal metering push-pull loss motion fill valve 1200 with the exception of the stem 1403, which only provides pushing mechanical motion in this embodiment. In some embodiments, the internal metering push loss motion fill valve comprises of an inlet conduit 1401, an outlet conduit 1402, a loss-motion stem 1403, a diaphragm 1404, a center metering hole 1405, a knuckle 1406, a back cavity 1407, a metering seal 1408, an arm 1409, a float 1410, a screw 1411, and a downtube 1412.

Similar to FIG. 12, in some embodiments, the internal metering push loss motion fill valve 1400 includes an inlet conduit 1401 comprising at least one in-line filter (not shown). In some embodiments, the flow of incoming water is perpendicular to the travel of the float 1410. The level in the tank where valve 1400 is installed is controlled by screw 1411 which raises and lowers the float in a vertical direction, changing the level at which the stem arm 1409 actuates the stem 1403. In some embodiments, the diaphragm 1404 is configured to engage the outlet seat 1410 when the stem arm 1409 is at its highest position. In some embodiments, stem 1403 includes a fluted section 1420, which includes a reduced cross-section configured to enable fluid to drain from back cavity 1407 through the seal drain 1421. The draining of fluid from the back cavity 1407 causes the pressure to drop below inlet pressure such that the inlet fluid pressure pushes the diaphragm 1404 away from the outlet seat 1410. In some embodiments, in an unactuated state, a sealing cross-section 1422 of stem 1403 engages the walls of seal drain 1421 allowing fluid to enter the back cavity 1407 via a center metering hole 1405. In some embodiments, because the surface area of the valve body 1430 in the back cavity 1407 is greater than the surface area of the front of the valve body 1430, the valve reseats against outlet seat 1410.

In some embodiments, the valve body 1430 includes the center metering hole 1405 configured to enable pressure to equalize between the inlet conduit 1401 and the back cavity 1407. In some embodiments, the center metering hole 1405 is configured to trap a front fluted section 1450 of the stem 1403 therebetween. The difference between FIG. 12 and FIG. 14 is that as the stem arm 1409 continues to pull the stem 1403, a front transition zone does not engage a front of the valve body 1430 with mechanical force. In some embodiments, as the stem 1403 is moved forward by the stem arm 1409 as the float 1410 rises, the seal drain 1421 is sealed by the sealing cross-section 1422 which allows pressure in the back cavity 1407 to equalize through the center metering hole 1405, where fluid flows between the fluted section 1450 and the valve body 1430. Similar to FIG. 12, in some embodiments, as the stem 1403 moves forward, a rear transition zone of the stem 1403 engages an inner valve body wall pushing the valve body 1430 forward with mechanical force.

In some embodiments, the inlet conduit 1401 is configured to enable fluid to flow through the center of the outlet tube 1402 and activate the seal 1404 by flexing the seal 1404 and uncovering the outlet 1402. In some embodiments, the seal 1404 is connected to the loss-motion stem 1403 that pushes the seal 1404 during the closing phase. In some embodiments, the seal 1404 comprises the metering hole 1405 on an interior portion configured to be directly in the path of the inlet 1401, allowing water to flow through the seal 1404 into the back cavity 1407. In some embodiments, as the water level within a conventional tank (not shown) rises, the float 1410, connected to the screw 1411, moves vertically along the bearing surface of the downtube 1412, and the arm 1409, connected to the screw 1411 and the stem 1403, translates this vertical motion of the float 1410 into horizontal motion of the stem 1403.

In some embodiments, the “on” position is determined by the float 1410 being at a “low” position, retracting the stem 1403 and unsealing the stem surface against the metering seal 1408. In some embodiments, during the opening phase of the “on” position, the actuation of the loss-motion stem 1403 breaks the seal releasing the pressure of the back cavity 1407. In some embodiments, the “off” position is determined by the float 1410 being at a “high” position, actuating the stem 1403. In some embodiments, in the “off” position, the stem 1403 seals against the metering seal 1408, sealing the back cavity 1407, allowing the pressure to equalize across the inlet 1401 and the back cavity 1407 during initial actuation. In some embodiments, as the arm 1409 continues to move, a feature on the arm 1409 captures the seal 1404 once again and mechanically pushes the seal 1404 closer to the “off” position. In some embodiments, the larger surface area of the back cavity 1407 causes the seal 1404 to fully close against the outlet 1402.

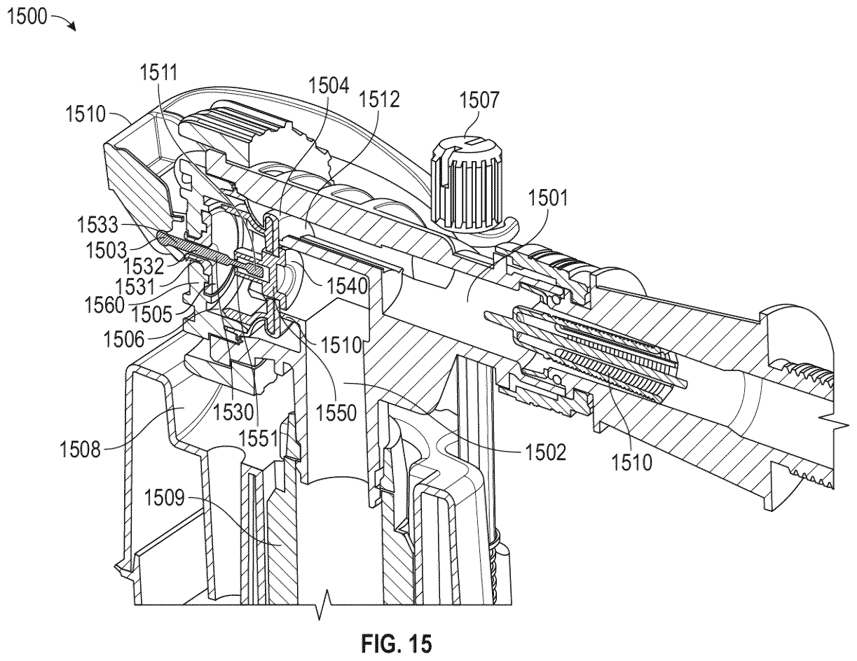

FIG. 15 depicts a section view of an external metering pull loss motion fill valve 1500 according to some embodiments. In some embodiments, the external metering pull loss motion fill valve comprises one or more of an inlet conduit 1501, an outlet conduit 1502, a loss-motion stem 1503, one or more metering holes 1504, a metering seal 1505, a back cavity 1506, a screw 1507, a float 1508, a downtube 1509, an arm 1510, a knuckle 1511, and a seal 1512.

In some embodiments, the external metering pull loss motion fill valve 1500 is substantially similar to the external metering push-pull loss motion fill valve 1100 shown in FIG. 11 with the exception of the stem 1503. In some embodiments, the external metering push loss motion fill valve 1500 includes an inlet conduit 1501 comprising at least one in-line filter 1570. In some embodiments, the flow of incoming water is perpendicular to the travel of the float 1508. In some embodiments, the level in the tank where valve 1500 is installed is controlled by screw 1507 which raises and lowers the float in a vertical direction, changing the level at which the stem lever 1510 actuates the stem 1503. In some embodiments, the diaphragm 1512 is configured to engage the outlet seat 1520 when the stem lever 1510 is at its highest position.

In some embodiments, stem 1503 includes a fluted section 1530, which includes a reduced cross-section configured to enable fluid to drain from back cavity 1506 through the seal drain 1531. In some embodiments, the draining of fluid from the back cavity 1506 causes the pressure to drop below inlet pressure such that the inlet fluid pressure pushes the diaphragm 1512 away from the outlet seat 1520. In some embodiments, in an unactuated state, a sealing cross-section 1533 of stem 1503 engages the walls of seal drain 1531 allowing fluid to pressurize the back cavity 1506 via metering holes 1504. In some embodiments, because the surface area of the valve body 1540 in the back cavity 1506 is greater than the surface area of the front face of the valve body 1540 the valve reseats against outlet seat 1520.

In some embodiments, the valve body 1540 includes a pull cavity 1550 configured to house a front portion of stem 1503. In some embodiments, the front portion includes a reduced cross-section 1551 and/or one or more expanded cross-sections with one or more transition zones configured to trap the front portion within the pull cavity 1550.

In some embodiments, as the float 1508 moves down the fluted section 1530 allows pressure to bleed from the back cavity 1506 unseating the diaphragm 1512. Similar to FIG. 11, in some embodiments, the stem 1503 is configured such that as the stem lever 1510 continues to pull the loss-motion stem 1503 rearward, the front transition zone engages the rear through-wall of the pull cavity 1550 resulting in mechanical force applied during opening. In some embodiments, as the stem 1503 is moved forward by the stem lever 1510 as the float 1508 rises, the seal drain 1531 is sealed by the sealing cross-section 1533 which allows pressure in the back cavity 1506 to equalize as previously described with reference to FIG. 11. The difference between FIG. 15 and FIG. 11 is that as the stem 1506 moves forward, a rear transition zone of the loss-motion stem 1503 does not engages an outside portion of the rear through-wall, and therefore no mechanical pushing force is applied to the valve body 1540.

In some embodiments, the water inlet 1501 flows around the exterior of the outlet tube 1502 and activates the seal 1512 by flexing the seal 1512 and uncovering the outlet 1502. In some embodiments, the seal 1512 is connected to the loss-motion stem 1503 that pulls the seal 1512 during the opening phase. In some embodiments, the seal 1512 comprises one or more metering holes 1504 on the exterior directly in the path of the inlet 1501 that allows water to flow through the seal 1512 into the back cavity 1506. In some embodiments, the incoming fluid flows through metering holes 1504 and between the valve body 1540 and the cap 1560, and/or through the valve body through a metering conduit (not shown), both of which are best shown in FIG. 7. In some embodiments, as the water level within a conventional tank (not shown) rises, the float 1508, connected to the screw 1507, moves vertically along the bearing surface of the downtube 1509, and the stem lever 1510, connected to the screw 1507 and the stem 1503, translates the vertical motion of the float 1508 into horizontal motion of the stem 1503.

In some embodiments, the “on” position is determined by the float 1508 being at a “low” position, retracting the stem 1503 and unsealing the stem surface against the metering seal 1505. In some embodiments, during the opening phase of the “on” position the initial actuation of the loss-motion stem lever 1510 breaks the metering seal 1505 and stem seal, releasing the pressure of the back cavity 1506. In some embodiments, as the stem lever 1510 continues to travel, the knuckle 1511 captures the seal 1512 and mechanically opens the seal 1512 further, creating a larger water flow path. In some embodiments, the “off” position is determined by the float 1508 being at a “high” position, actuating the stem 1503. In some embodiments, in the “off” position, the stem 1503 seals the back cavity 1506 allowing the pressure to equalize across the inlet 1501 and the back cavity 1506. In some embodiments, the larger surface area of the back cavity 1506 forces the seal 1512 to fully close against the outlet 1502.

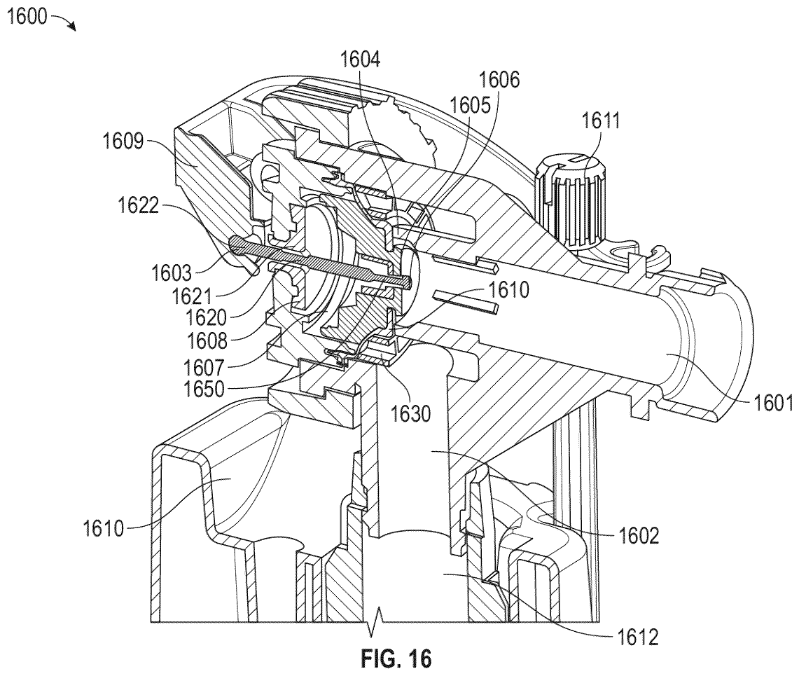

FIG. 16 demonstrates a section view of an internal metering pull loss motion fill valve 1600 according to some embodiments. In some embodiments, the internal metering push loss motion fill valve 1600 is substantially similar to the internal metering push-pull loss motion fill valve 1200 with the exception of the stem 1603, which only provides pulling mechanical motion against the valve body 1630. In some embodiments, the internal metering pull loss motion fill valve comprises of an inlet conduit 1601, an outlet conduit 1602, a loss-motion stem 1603, a diaphragm 1604, a metering hole 1605, a knuckle 1606, a back cavity 1607, a metering seal 1608, an arm 1609, a float 1610, a screw 1611, and a downtube 1612.

Similar to FIG. 12 and FIG. 14, in some embodiments, the internal metering push loss motion fill valve 1400 includes an inlet conduit 1601 comprising at least one in-line filter (not shown). In some embodiments, the flow of incoming water is perpendicular to the travel of the float 1610. In some embodiments, the level in the tank where fluid valve 1600 is installed is controlled by screw 1611 which raises and lowers the float in a vertical direction, changing the level at which the stem arm 1609 actuates the stem 1603. In some embodiments, the diaphragm 1604 is configured to engage the outlet seat 1610 when the stem lever 1609 is at its highest position. In some embodiments, stem 1603 includes a fluted section 1620, which includes a reduced cross-section configured to enable fluid to drain from back cavity 1607 through the seal drain 1621. In some embodiments, the draining of fluid from the back cavity 1607 causes the pressure to drop below inlet pressure such that the inlet fluid pressure pushes the diaphragm 1604 away from the outlet seat 1610. In some embodiments, in an unactuated state, a sealing cross-section 1622 of stem 1604 engages the walls of seal drain 1621 allowing fluid to pressurize the back cavity 1607 via a center metering hole 1605. In some embodiments, because the surface area of the valve body 1630 in the back cavity 1607 is greater than the surface area of the front the valve reseats against outlet seat 1610.

In some embodiments, the valve body 1630 includes a center metering hole 1605 configured to enable pressure to equalize between the inlet conduit 1601 and the back cavity 1607. In some embodiments, the center metering hole 1605 is configured to trap a front fluted section 1650 of the stem 1603 therebetween. The difference between FIG. 14 and FIG. 16 is that as the stem arm 1609 continues to pull the stem 1603, a front transition zone does engage a front of the valve body 1630 pulling with mechanical force. In some embodiments, as the stem 1603 is moved forward by the stem arm 1609 as the float 1610 rises, the seal drain 1621 is sealed by the sealing cross-section 1622 which allows pressure in the back cavity 1607 to equalize through the center metering hole, where fluid flows between the fluted section 1650 and the valve body 1630. Unlike FIG. 14, in some embodiments, as the stem 1603 moves forward, a rear transition zone of the stem 1603 does not engage an inner valve wall with mechanical force.

In some embodiments, the water inlet 1601 flows through the center of the outlet tube 1602 and activates the seal 1604 by flexing the seal 1604 and uncovering the outlet 1602. In some embodiments, the seal 1604 is connected to the loss-motion stem 1603 that pulls the seal 1604 during the opening phase. In some embodiments, the seal 1604 comprises the metering hole 1605 on the interior directly in the path of the inlet 1601 that allows water to flow through the seal 1604 into the back cavity 1607. In some embodiments, as the water level within a conventional tank (not shown) rises, the float 1610, connected to the screw 1611, moves vertically along the bearing surface of the downtube 1612, and the arm 1609, connected to the screw 1611 and stem 1603, translates this vertical motion of the float 1610 into horizontal motion of the stem 1603.

In some embodiments, the “on” position is determined by the float 1610 being at a “low” position, retracting the stem 1603 and unsealing the stem surface against the metering seal 1608. In some embodiments, during the opening phase of the “on” position, the initial actuation of the loss-motion stem 1603 breaks the seal 1604 releasing the pressure of the back cavity 1607. In some embodiments, as the stem 1603 continues to travel, the knuckle 1606 captures the seal 1604 and mechanically opens the seal 1604 further creating a larger water flow path. In some embodiments, the “off” position is determined by the float 1610 being at a “high” position, actuating the stem 1603. In some embodiments, in the “off” position, the stem 1603 seals against the metering seal 1608, sealing the back cavity 1607, allowing the pressure to equalize across the inlet 1601 and the back cavity 1607 during initial actuation. In some embodiments, the larger surface area of the back cavity 1607 causes the seal 1604 to fully closes against the outlet 1602.

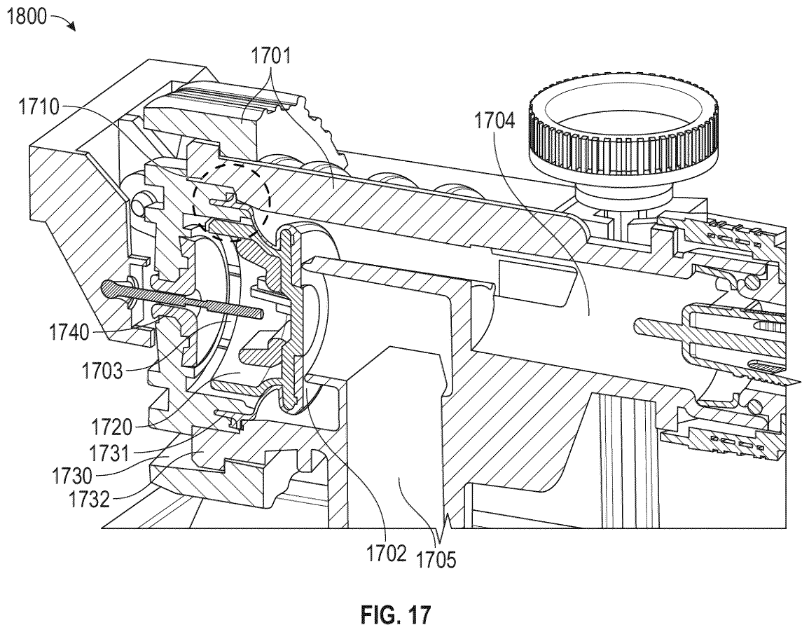

FIGS. 17, 18, and 19 show various views of a pressure relief portion 1710 common to all valves shown in FIGS. 7-16. In some embodiments, all valves in FIGS. 7-16 include a diaphragm 1702 wrapped around a valve body 1720 that engages a valve cap 1730. In some embodiments, the valve cap 1730 includes a diaphragm recess 1731 configured to house at least a portion of the end of the diaphragm 1702. In some embodiments, each valve is configured and arranged secure the diaphragm end in place by trapping it between the diaphragm recess 1731 and the inlet wall 1732. In each of FIGS. 7-16, the diaphragm includes a pressure relief portion 1710 which is located where the diaphragm is trapped between the inlet wall 1732 and the valve cap 1730 in some embodiments.

FIG. 17 shows a section view of a pressure relief seal according to some embodiments. In some embodiments, the pressure relief seal comprises one or more of a pressure vessel 1701, a seal 1702, a back cavity 1703, an inlet 1704, and an outlet 1705. In some embodiments, in the “on” or opened position, pressure from the inlet 1704 forces the fill valve seal 1702 to actuate once pressure has been bled through the seal drain 1740, as described with regard to FIGS. 7-16, opening the valve and allowing water to flow through a gap between the seal 1702 and the outlet 1705. As previously described when the valve is closed, the pressure is equalized across the back cavity 1703 and the inlet 1704. In some embodiments, the larger surface area of the back cavity 1703 forces the seal 1702 to press closed against the outlet 1705. In each of the valves pressure relief occurs at when incoming pressure from the inlet 1704 exceeds a maximum value (e.g., 50 psi) and the in incoming fluid is allowed to bleed through the sealing area of the pressure vessel 1701.

FIG. 18 illustrates the metering hole arrangement similar to that of FIGS. 11, 13, and 15, and also shows the diaphragm 1810 fitted to the valve cap 1820. In some embodiments, the diaphragm 1810 is made from a flexible material (e.g., rubber) where the elasticity of the material is sufficient to enable the diaphragm 1810 to flex backward when the pressure in the back cavity is lower (e.g., less than 0.5 psi) than the inlet pressure and flex forward with sufficient force to seal the outlet seat when the pressure is substantially equal (e.g. within 0.2 psi) between the back cavity and the inlet. In some embodiments, in the “off” or closed position one or more metering holes 1806 allows fluid flow from the inlet to the back cavity as previously described. The incoming fluid flows through metering holes 1806 and between the valve body 1830 and the cap 1820, and/or through the valve body through a metering conduit.

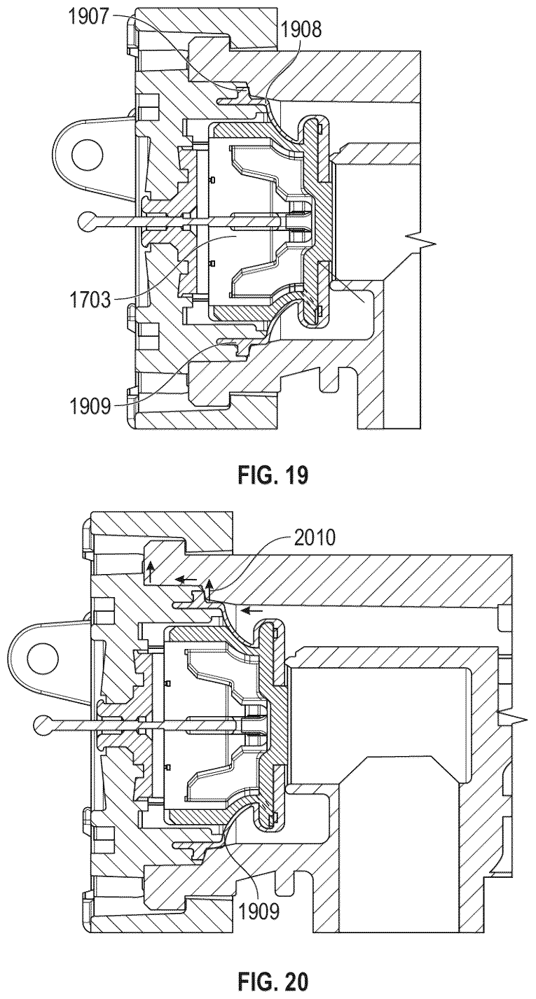

FIG. 19 displays a zoomed view of the pressure relief seal in FIG. 7 in a closed position according to some embodiments. In some embodiments, the section view of the pressure relief seal comprises a back cavity 1703, a pressure relief seal 1907, a pressure activated seal 1908, and an internal sealing surface 1909. In some embodiments, as the pressure between an inlet and the back cavity 1703 continues to equalize, the pressure relief feature bleeds the excess pressure from the inlet until the pressure equalizes and the pressure activated sealing feature 1908 seals against the internal sealing surface 1909 fully closing the pressure vessel seal, preventing damage from water hammer. In some embodiments, the diaphragm is configured to seal a relief opening at the location of the pressure relief seal 1907 until excessive inlet pressure causes the pressure relief seal 1907 to flex away from the trapped area allowing fluid to escape.

FIG. 20 portrays a section view of the pressure relief seal in FIG. 17 with a pressure relief path of the escape according to some embodiments.

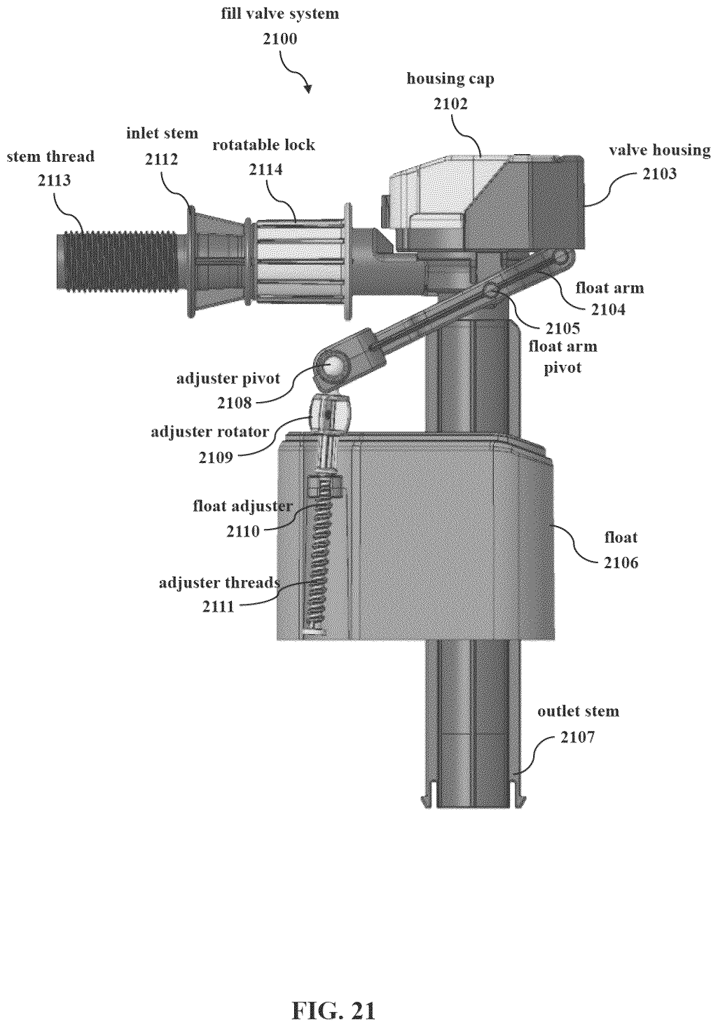

FIG. 21 illustrates a fill valve system 2100 that is configured to regulate the delivery of fluid into a tank or vessel, in accordance with some embodiments. In some embodiments, the fill valve system 2100 includes a housing cap 2102 that is mounted to an upper portion of a valve housing 2103 configured to enable access to internal components. In some embodiments, a float arm 2104 is pivotably coupled to the valve housing 2103 at a float arm pivot 2105. In some embodiments, a float 2106 is secured to a distal end of the float arm 2104 and is configured to rise and fall in response to fluid level changes within the vessel. An outlet stem 2107 extends laterally from the valve housing 2103 and defines a flow path through which fluid is discharged to a downstream outlet, in accordance with some embodiments.

In some embodiments, an adjuster pivot 2108 couples the float arm 2104 to an adjuster rotator 2109 that is rotatable relative to the valve housing 2103. In some embodiments, rotation of the adjuster rotator 2109 causes axial displacement of a float adjuster 2110, altering the vertical position of the float arm 2104. In some embodiments, the float adjuster 2110 is configured to engage adjuster threads 2111 formed along the valve housing 2103.

In some embodiments, the valve housing 2103 includes a removable inlet stem 2112 that is configured to couple to and/or extend into the valve housing 2103. A stem thread 2113 formed along an outer surface of the inlet stem 2112 facilitates secure attachment to a fluid supply fitting, in accordance with some embodiments. In some embodiments, a rotatable lock 2114 is positioned near the interface between the inlet stem 2112 and the valve housing 2103. The rotatable lock 2114 is configured to selectively permit or restrict angular rotation of the valve housing 2103 relative to the inlet stem 2112, discussed further infra, in accordance with some embodiments.

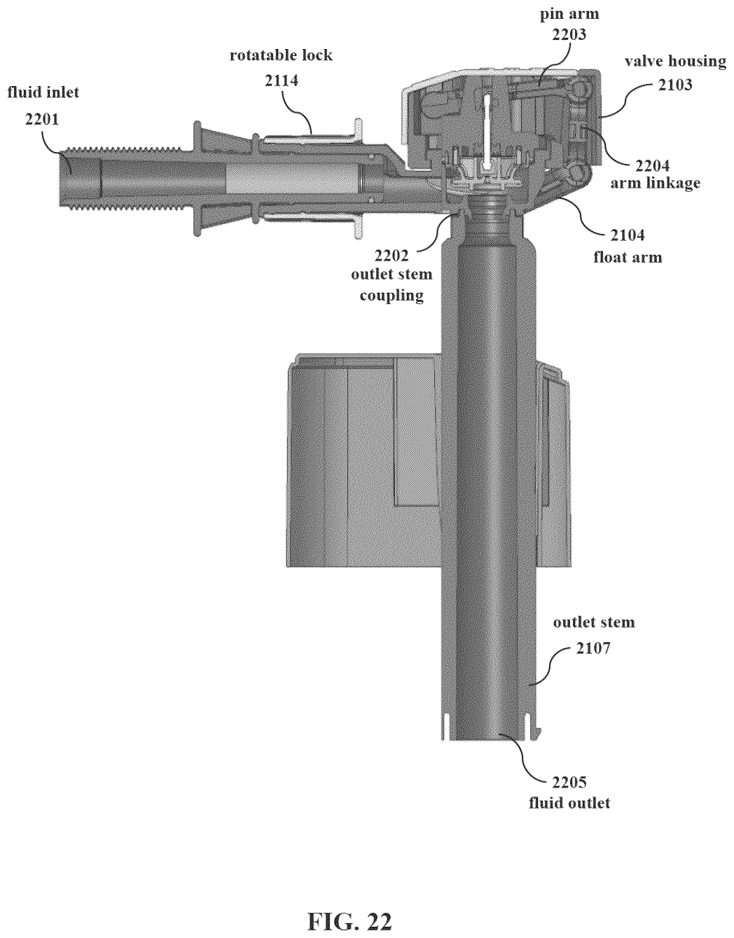

FIG. 22 shows a cross-sectional view of the fill valve system 2100, in accordance with some embodiments. In some embodiments, the stem 2112 includes a fluid inlet 2201 configured to receive fluid from a fluid supply source. In some embodiments, the fluid inlet 2201 is in fluid communication with an internal chamber of the valve housing 2103. In some embodiments, a rotatable lock 2114 is disposed between the stem 2112 and the valve housing 2103 and is configured to engage the inlet stem 2112 to secure the inlet stem to the valve housing 2103. In some embodiments, an outlet stem coupling 2202 is configured to couple the valve housing 2103 with the outlet stem 2107.

In some embodiments, the valve actuator includes a pin arm 2203 disposed within the valve housing 2103. In some embodiments, the pin arm 2203 is pivotally connected to an arm linkage 2204, which in turn is coupled to the float arm 2104. Vertical displacement of the float arm 2104 causes corresponding motion of the pin arm 2203 via the arm linkage 2204, in accordance with some embodiments. In some embodiments, the outlet stem 2107 is in fluid communication with a fluid outlet 2205, which directs fluid out of the fill valve system 2100 and into the surrounding fluid container (e.g., a cistern, a toilet bowl or other container). The valve housing 2103 defines an internal flow path that regulates the passage of fluid between the fluid inlet 2201 and the fluid outlet 2205 in response to the position of the float 2106, in accordance with some embodiments.

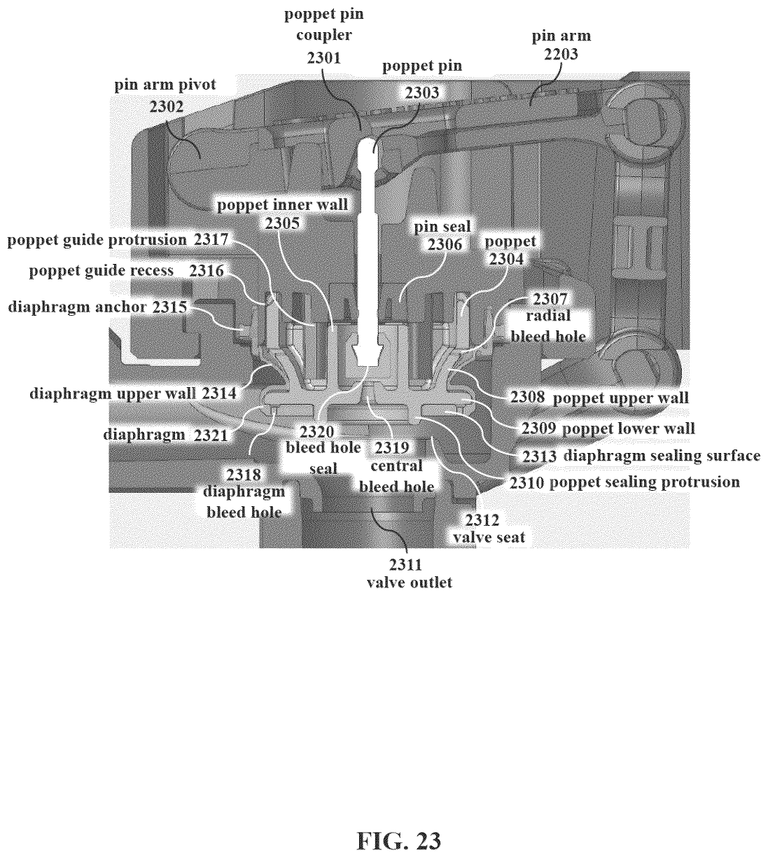

FIG. 23 depicts a cross-sectional view of internal actuation components of the fill valve system 2100, in accordance with some embodiments. In some embodiments, a pin arm 2203 is pivotally connected to a poppet pin coupler 2301, which transmits mechanical motion from the float mechanism to a poppet pin 2303. In some embodiments, the pin arm 2203 is mounted on a pin arm pivot 2302, allowing it to rotate in response to changes in the fluid level. In some embodiments, the poppet pin 2303 extends axially within the valve housing 2103 and is mechanically linked to a poppet 2304. In some embodiments, the poppet 2304 includes a poppet cavity defined by a poppet upper wall 2308 and poppet lower wall 2309 wall 2305. In some embodiments, a poppet inner wall 2305 is disposed within the poppet cavity and surrounds the poppet pin 2303. In some embodiments, an inner portion of the poppet inner wall 2305 forms part of the poppet cavity. In some embodiments, a pin seal 2306 surrounds the poppet pin 2303 to inhibit fluid leakage along the pin axis.

In some embodiments, a radial bleed hole 2307 is formed in the wall of the poppet upper wall 2308 and enables fluid communication with the poppet cavity. In some embodiments, the poppet 2304 upper wall 2308 and lower wall 2309 define an internal cavity for pressure balancing between inlet pressure and poppet pressure. In some embodiments, a poppet sealing protrusion 2310 is formed along the lower face of the poppet 2304 and is configured to engage an inner wall of the valve outlet 2311 below the valve seat 2312 to provide a greater sealing surface. The valve outlet 2311 is positioned downstream of the poppet 2304 and directs fluid toward the outlet stem coupling 2202 and outlet stem 2107, in accordance with some embodiments.

In some embodiments, the poppet 2304 is at least partially surrounded by and engaged with a diaphragm 2321, where a diaphragm sealing surface 2313 is configured to engage a periphery of the valve seat 2312. In some embodiments, a combination of the poppet pin 2303, poppet 2304, and/or diaphragm 2321 creates a diaphragm assembly to regulate sealing engagement. In some embodiments, the diaphragm assembly includes a diaphragm upper wall 2314 that is secured to a diaphragm anchor 2315 within the valve housing 2103. In some embodiments, a poppet guide recess 2316 is formed in the valve housing 2103 and is configured to vertically guide at least a portion of the poppet upper wall 2308 during movement of the valve assembly. In some embodiments, the valve housing includes a poppet guide protrusion 2317 configured to engage the outer radial surface of the poppet inner wall 2305 to aid in vertical travel, relative to a vertical axis of the valve outlet 2311.

In some embodiments, a diaphragm bleed hole 2318 is formed or created in the diaphragm sealing surface 2313 of the diaphragm 2321 to allow restricted fluid communication across the diaphragm 2321. In some embodiments, the diaphragm bleed hole 2318 is configured to enable fluid to pass between the diaphragm 2321 and the poppet 2304, through a radial bleed hole 2307 within the poppet 2304, and into the poppet cavity. In some embodiments, the poppet pin 2303 includes a bleed hole seal 2320 disposed at the lower surface that configured to obstruct the central bleed hole 2319 to trap the fluid within the poppet cavity to allow for equalization of pressure on both sides of the diaphragm assembly.

In some embodiments, the poppet pin 2303 is positioned entirely within the internal volume of the poppet 2304 and does not extend through the central bleed hole 2319. Instead, in some embodiments the central bleed hole 2319 is sealed from the interior of the poppet cavity. This configuration provides an advantage over a poppet pin that extends through the central bleed hole. In those arrangements, water containing dissolved minerals may come into contact with the poppet pin and the surfaces surrounding the central bleed hole. Over time, mineral deposits can accumulate along this interface, preventing the poppet pin from sealing effectively against the bleed hole on the fluid flow side, allowing unintended fluid leakage.

By positioning the poppet pin 2303 fully behind the central bleed hole 2319, the system avoids direct contact between the sealing interface and exposed fluid flow, where the poppet cavity only receives a small fraction of any fluid from the fluid inlet 2201. In some embodiments, this arrangement reduces the likelihood of mineral buildup at critical sealing locations and contributes to more stable and reliable pressure control over the life of the valve. Furthermore, because the poppet pin 2303 does not penetrate through the bleed path, the configuration simplifies sealing requirements and reduces potential wear, in accordance with some embodiments.

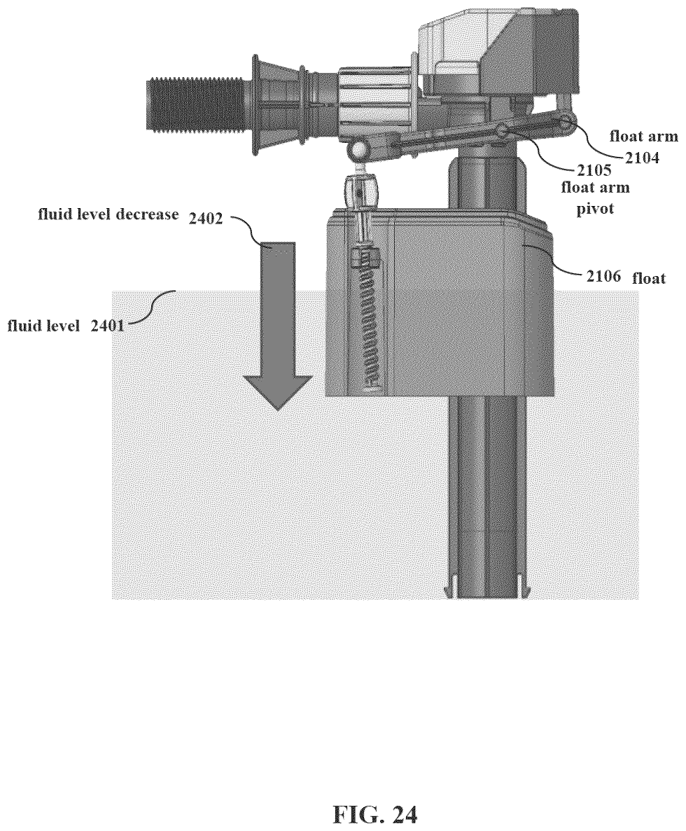

FIG. 24 illustrates the fill valve system 2100 in a state of active fluid discharge during a flush cycle, in accordance with some embodiments. In some embodiments, a fluid level 2401 within the tank is shown as fluid level decrease 2402 is occurring. The lowering of the fluid level 2401 results in a corresponding decrease in buoyant force on the float 2106, causing the float arm 2104 to rotate downward about the float arm pivot 2105. As fluid exits the vessel and the fluid level 2401 continues to drop, the float 2106 remains in a lowered position, keeping the valve in an open state to allow continued fluid entry.

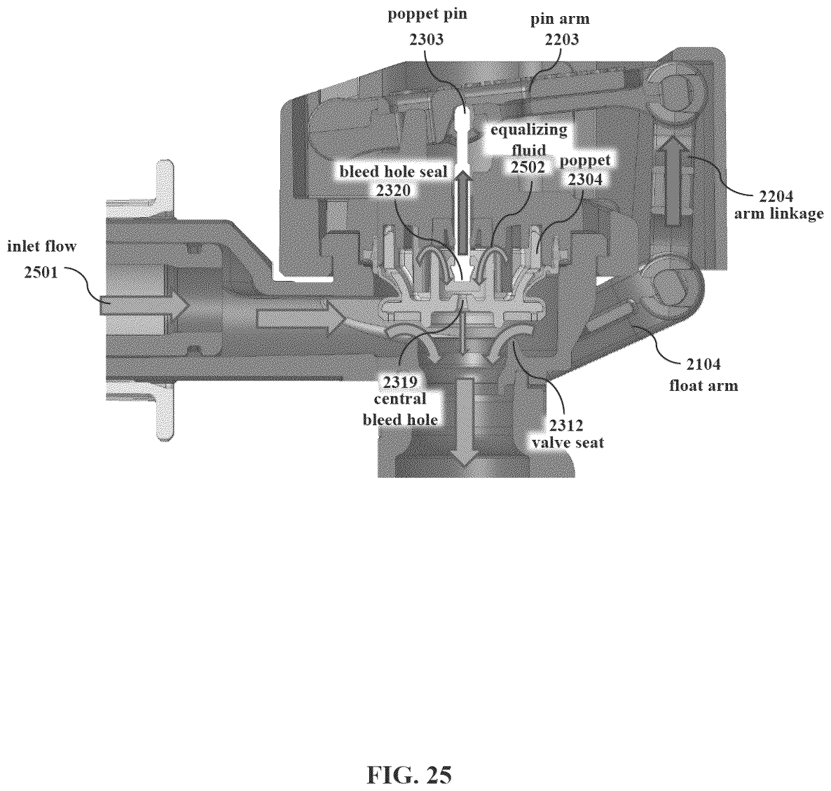

FIG. 25 shows the fill valve system 2100 in a flush actuation state, in accordance with some embodiments. In some embodiments, downward movement of the float 2106 causes the float arm 2104 to pivot downward about the float arm pivot 2105. In some embodiments, this downward rotation of the float arm 2104 translates motion through the arm linkage 2204 and actuates the pin arm 2203. As the pin arm 2203 pivots about the pin arm pivot 2302, it displaces the poppet pin 2303 vertically, thereby unseating the poppet 2304 from the valve seat 2312 and allowing fluid to flow into the tank through the valve outlet 2311, in accordance with some embodiments.

In some embodiments, as the poppet pin 2303 moves upward, it disengages the bleed hole seal 2320 from the central bleed hole 2319. In some embodiments, the unsealing of the central bleed hole 2319 allows equalizing fluid 2502 within the poppet cavity to flow out through the central bleed hole 2319, rapidly decreasing pressure above the diaphragm assembly.

In some embodiments, this reduction in pressure within the poppet cavity creates a pressure differential across diaphragm assembly, causing fluid entering the valve housing 2103 through the fluid inlet 2201 (represented by inlet flow 2501) to exert an upward force on the diaphragm sealing surface 2313. This pressure differential lifts the diaphragm assembly, disengaging the poppet sealing protrusion 2310 from the valve seat 2312 and permitting fluid flow through the valve outlet 2311, in accordance with some embodiments. In some embodiments, the poppet pin 2303 includes one or more outwardly extending protrusions configured to mechanically engage at least a portion of the poppet inner wall 2305. These protrusions mechanically assist in lifting the poppet 2304 concurrently with the fluid-driven actuation, enhancing the responsiveness of the valve during the flush cycle, in accordance with some embodiments.

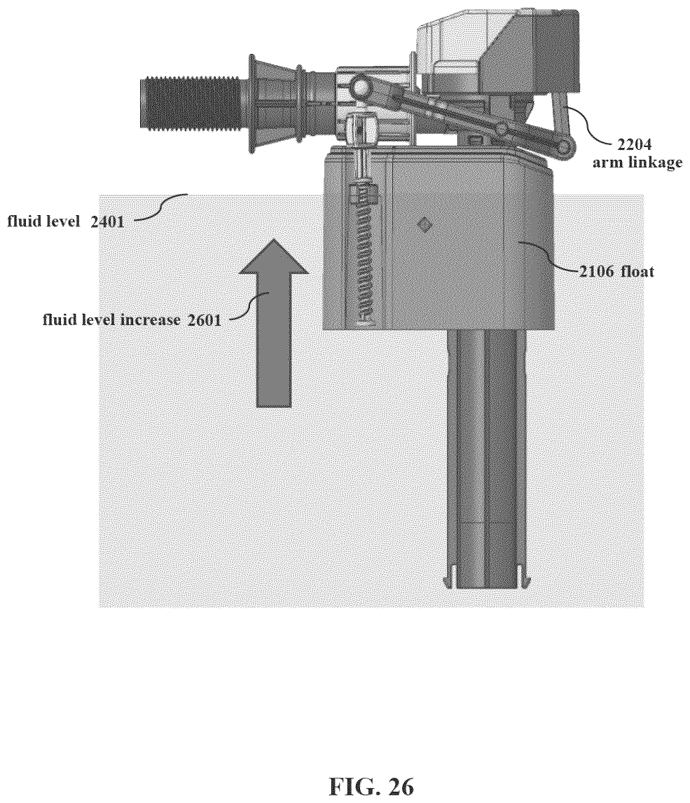

FIG. 26 illustrates fill actuation 2602 of a fill valve system 2100, in accordance with some embodiments. In some embodiments, a fluid level increase 2601 is shown relative to an initial fluid level 2401. In some embodiments, the rising fluid level 2601 causes float 2106 to ascend along float arm 2104, thereby pivoting the float arm 2104 upward about float arm pivot 2105.

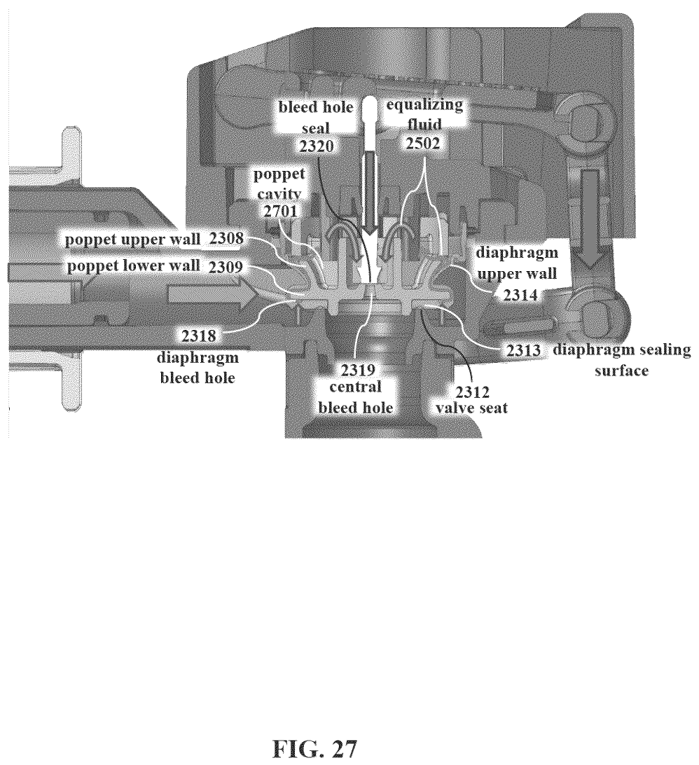

FIG. 27 shows the closing and sealing operation of the fill valve system 2100, in accordance with some embodiments. In some embodiments, upward movement of the float 2106 drives the arm linkage 2204 and pin arm 2203 downward, causing the poppet pin 2303 to be displaced downward. In some embodiments, the downward movement of the poppet pin 2303 urges the bleed hole seal 2320 into sealing engagement with the central bleed hole 2319, thereby closing the bleed path.

In some embodiments, once the central bleed hole 2319 is sealed, fluid from the inlet flows through the diaphragm bleed hole 2318 into the space between the diaphragm sealing surface 2313 and the poppet lower wall 2309, in accordance with some embodiments. In some embodiments, the fluid then travels upward between the diaphragm upper wall 2314 and the poppet upper wall 2308 into the poppet cavity 2701. In some embodiments, the accumulation of fluid in the poppet cavity 2701 equalizes pressure on the upper and lower surfaces of the poppet 2304, thereby maintaining the poppet sealing protrusion 2310 and/or the diaphragm sealing surface 2313 in sealing engagement with the valve seat 2312, in accordance with some embodiments. In some embodiments, this configuration ensures reliable valve closure and minimizes leakage once the float 2106 reaches its shutdown position.

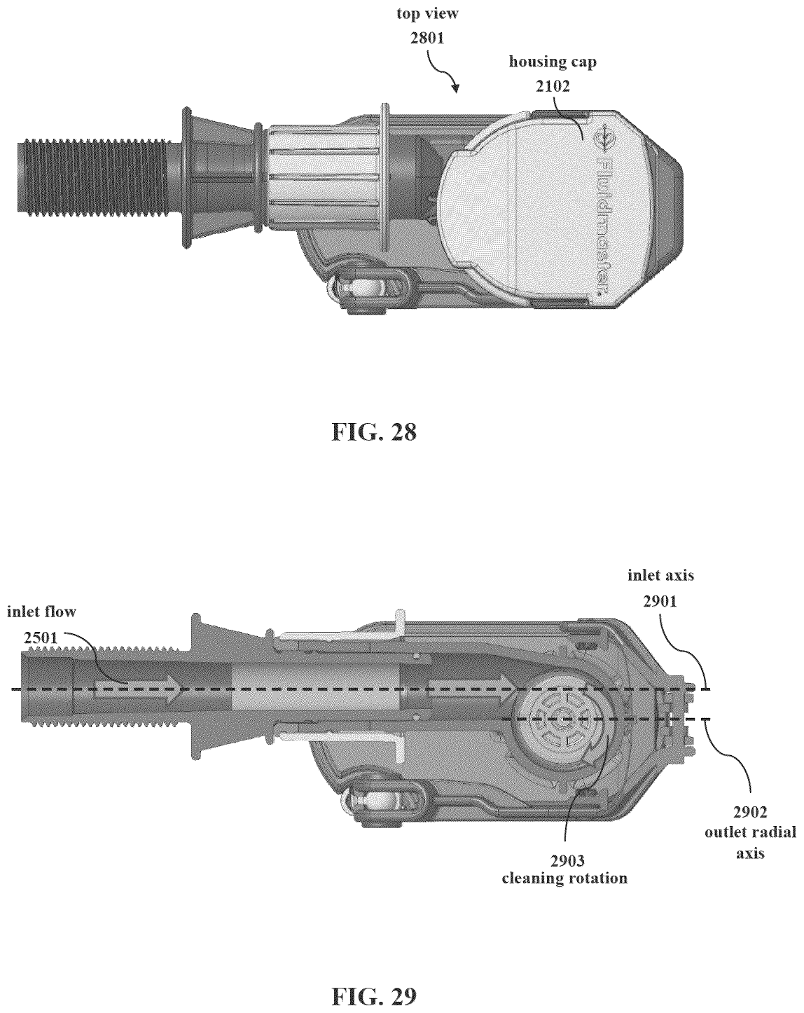

FIG. 28 depicts a top view 2801 of the housing cap 2102 of the fill valve system 2100, in accordance with some embodiments.

FIG. 29 shows a sectional view of the fill valve system 2100 showing an inlet axis 2901 offset from an outlet radial axis 2902, in accordance with some embodiments. In some embodiments, the inlet axis 2901 of the inlet stem 2112 is laterally displaced relative to the outlet radial axis 2902, defined at least in part by the longitudinal axis of the outlet stem 2107. In some embodiments, the offset between inlet axis 2901 and outlet radial axis 2902 establishes a cleaning rotation 2903 of the valve housing 2103 about the inlet stem 2112. The cleaning rotation 2903 sweeps internal flow passages and seating surfaces, preventing buildup of mineral scale and debris, in accordance with some embodiments.

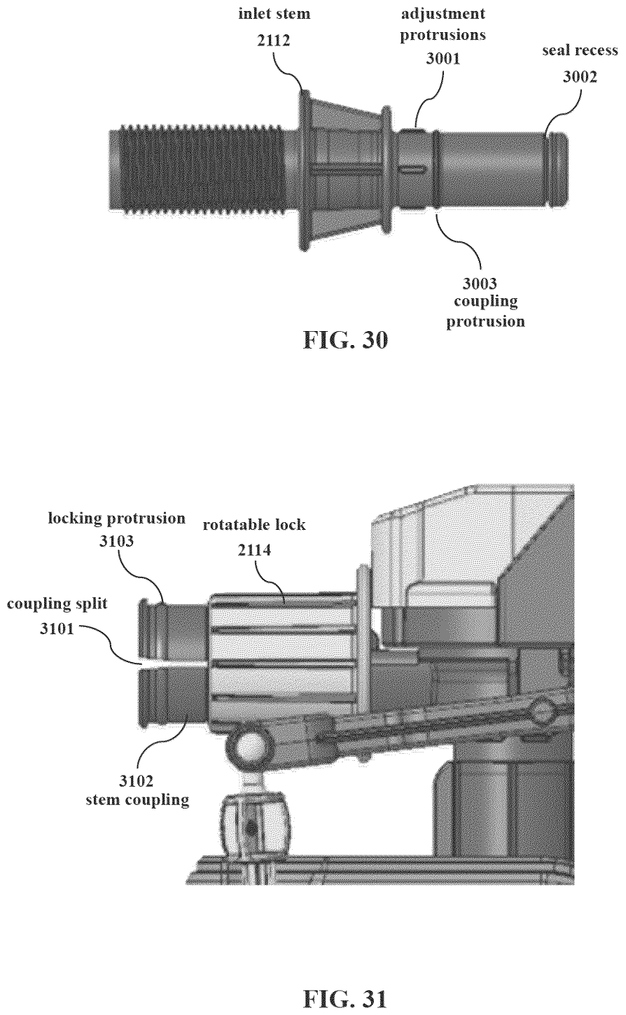

FIG. 30 illustrates an exploded view of the inlet stem assembly of the fill valve system 2100, in accordance with some embodiments. In some embodiments, the inlet stem 2112 includes one or more adjustment protrusions 3001 arranged circumferentially along its external surface. In some embodiments, the one or more adjustment protrusions 3001 are configured to interface with one or more respective adjustment recesses (see FIG. 29) defined in an internal wall of the stem coupling 3102, providing discrete angular indexing positions, in accordance with some embodiments. In some embodiments, coupling protrusions 3103 project radially inward from the inlet stem 2112 to engage portions of the inner wall of the stem coupling 3102 for placement and/or sealing, in accordance with some embodiments. In some embodiments, the inlet stem 2112 includes a seal recess 3102 configured to prevent vertical movement of a seal during assembly.

FIG. 31 illustrates features of the stem coupling 3102, in accordance with some embodiments. In some embodiments, the stem coupling 3102 is formed as a split collar featuring a coupling split 3101 that permits radial expansion and contraction for snap fit installation over the inlet stem 2112. In some embodiments, the stem coupling 3102 is configured to receive the coupling protrusion 3103 on the inlet stem 2112 to form an interference fit that restricts both axial movement, in accordance with some embodiments. In some embodiments, locking protrusion 3103 is configured to engage an inner surface of rotatable lock 2114 to fix the rotatable lock 2114 axially. In some embodiments, the rotatable lock 2114 is positioned on the stem coupling 3102 and is operable to lock the valve housing 2103 in a plurality of selected orientations relative to the inlet stem 2112, thereby enabling vertical alignment of the outlet stem 2107 following installation, in accordance with some embodiments.

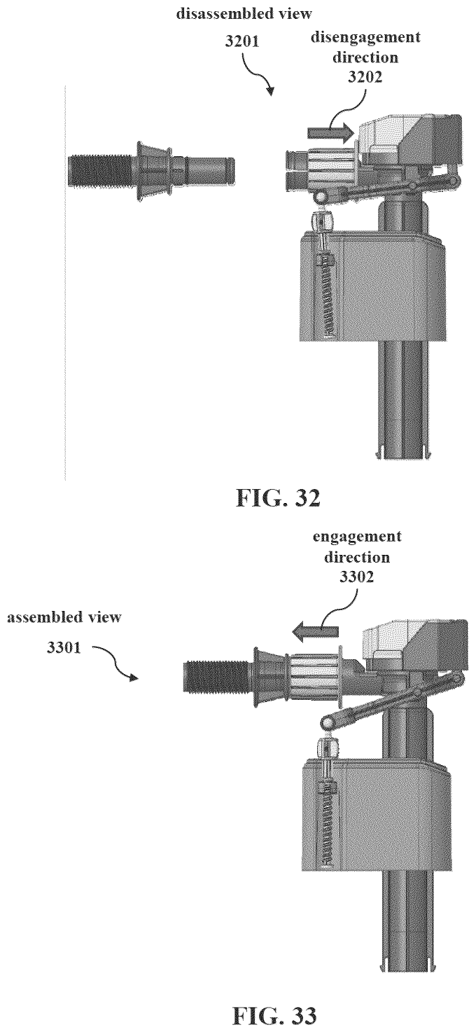

FIGS. 32 and 33 depict the assembly process of the inlet stem 2112, stem coupling 3102, and rotatable lock 2114, in accordance with some embodiments. FIG. 32 shows a disassembled view 3201 of the inlet stem 2112 and split stem coupling 3102 prior to engagement. The coupling split 3101 permits radial expansion of the stem coupling 3102 to slip over the adjustment protrusions 3001 on the inlet stem 2112. The rotatable lock 2114 is shown in a disengaged orientation, allowing the stem coupling 3102 to rotate freely about the inlet stem 2112, as indicated by the disengagement direction 3202, in accordance with some embodiments.

FIG. 33 shows an assembled view 3301 following snap fit installation of the stem coupling 3102 onto the inlet stem 2112, in accordance with some embodiments. The internal coupling recesses 3102 of the stem coupling 3102 engage the one or more adjustment protrusions 3001 on the inlet stem 2112, when moved in the engagement direction 3102, to provide discrete angular indexing positions, in accordance with some embodiments.

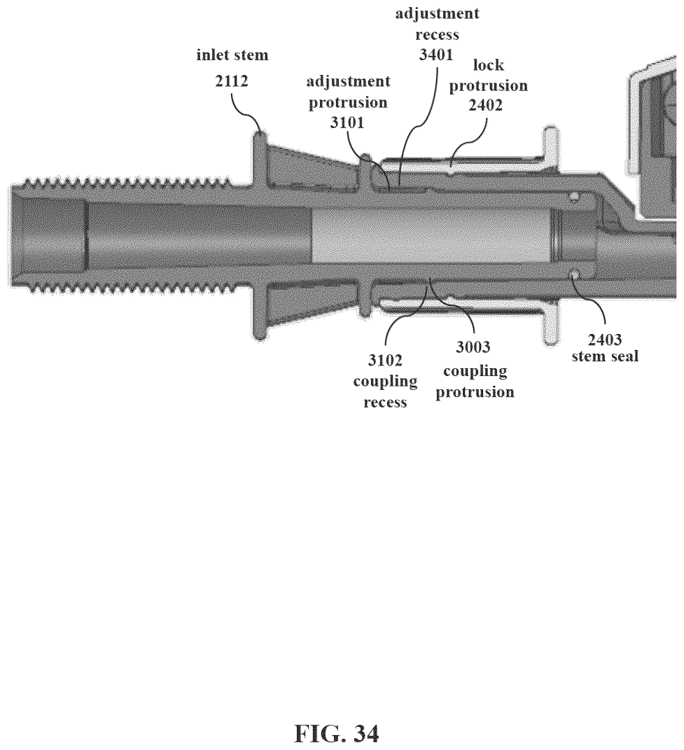

FIG. 34 illustrates a cross-sectional view of the interface between the inlet stem 2112 and the stem coupling 3102, in accordance with some embodiments. In some embodiments, an adjustment protrusion 3001 projecting from the exterior surface of the inlet stem 2112 is received within a complementary adjustment recess 3401 formed in the interior surface of the stem coupling 3102. In some embodiments, the engagement of the adjustment protrusion 3001 and adjustment recess 3401 establishes discrete angular indexing positions and resists inadvertent rotation of the valve housing 2103 relative to the inlet stem 2112. In some embodiments, a lock protrusion 3402 formed on the rotatable lock 2114 engages with a mating feature on the stem coupling 3102 to secure the selected orientation. In some embodiments, a stem seal 3403 is positioned within the stem seal recess 3103 to inhibit fluid leakage along the stem interface. The combined action of the mechanical engagement features and the stem seal 3403 maintains both precise rotational alignment and fluid tight integrity of the fill valve system 2100 during operation, in accordance with some embodiments.

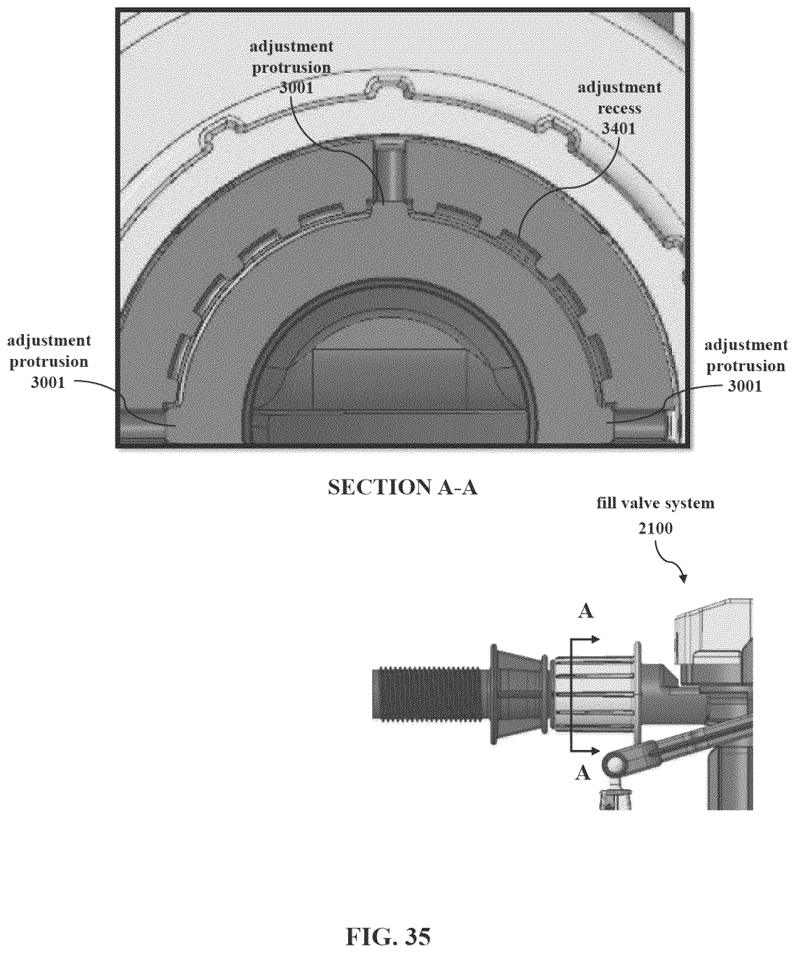

FIG. 35 shows a cross-sectional view taken along line A-A of the assembled inlet stem 2112 and stem coupling 3102, in accordance with some embodiments. In some embodiments, one or more adjustment protrusions 3001 (e.g., 4) are arranged circumferentially around the external surface of the inlet stem 2112. In some embodiments, each adjustment protrusion 3001 is received within a corresponding adjustment recess 3401 formed in the interior surface of the stem coupling 3102. In some embodiments, the radial interference between each adjustment protrusion 3001 and its adjustment recess 3401 establishes discrete rotational indexing positions, preventing unintended rotation of the valve housing 2103 relative to the inlet stem 2112. In some embodiments, the angular spacing of the adjustment protrusions 3001 and adjustment recesses 3401 is selected to provide a desired range and resolution of rotational adjustment.

In some embodiments, engagement of the adjustment protrusions 3001 within the adjustment recesses 3401 maintains the alignment of the outlet stem 2107 in a predetermined orientation following installation. Furthermore, the stem seal 3403 (shown in FIG. 34) continues to provide a fluid tight interface between the inlet stem 2112 and the stem coupling 3102 during rotational indexing, in accordance with some embodiments.

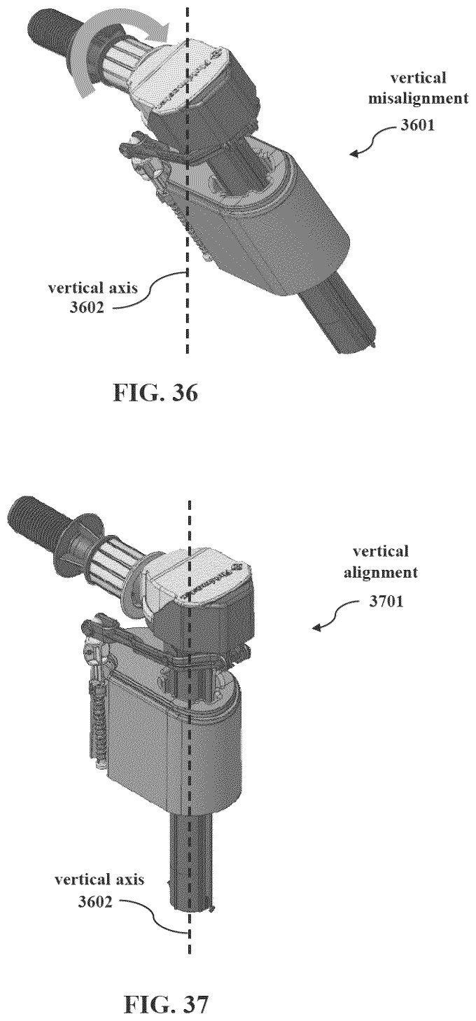

FIG. 36 depicts a vertically misaligned state 3601 of the fill valve system 2100, in accordance with some embodiments. In some embodiments, the valve housing 2103 and outlet stem 2107 are shown tilted relative to a vertical axis 3602 defined by the inlet stem 2112. In some embodiments, this misalignment occurs after initial installation when the inlet stem 2112 is secured but the valve housing 2103 has not yet been rotated into its final orientation. This is a common problem in the art for valves that do not have the features described herein and can result in damage to the valve from fluid flow forces. In some embodiments, the rotatable lock 2114 is momentarily disengaged to permit angular adjustment of the valve housing 2103 about the inlet stem 2112 to solve this problem, in accordance with some embodiments.

FIG. 37 illustrates the fill valve system 2100 in a vertically aligned configuration 3701, in accordance with some embodiments. In some embodiments, rotation of the valve housing 2103 about the inlet stem 2112 brings the outlet stem 2107 into alignment with the vertical axis 3602. In some embodiments, once the desired orientation is reached, the interference between the adjust protrusions 3101 and the adjustment recesses 3401 engage to lock the valve housing 2103 in place, thereby preventing further rotation without a force greater than a gravitational moment about a center of mass of the fluid valve assembly 2100. This vertical alignment facilitates vertical downward fluid flow from the outlet stem 2107, reducing moment forces caused by misalignment of the fluid flow with gravity, in accordance with some embodiments.

The subject matter described herein are directed to technological improvements to the field of fill valves for water tanks by providing solutions to low supply pressures. The disclosure describes the specifics of how a machine implements the system and its improvements over the prior art. Indeed, the systems and methods described herein were unknown and/or not present in the public domain at the time of filing, and they provide a technologic improvements/advantages not known in the prior art. Furthermore, the system includes unconventional steps that confine the claims to useful applications.

It is understood that the system is not limited in its application to the details of construction and the arrangement of components set forth in the previous description or illustrated in the drawings.

The system and methods disclosed herein fall within the scope of numerous embodiments. The previous discussion is presented to enable a person skilled in the art to make and use embodiments of the system. Any portion of the structures and/or principles included in some embodiments, can be applied to any and/or all embodiments: it is understood that features from some embodiments presented herein are combinable with other features according to some other embodiments. For example, although shown as two different embodiments, features from the hybrid pilot valve may be readily incorporated into the balanced piston valve. Thus, some embodiments of the system are not intended to be limited to what is illustrated but are to be accorded the widest scope consistent with all principles and features disclosed herein.

Some embodiments of the system are presented with specific values and/or setpoints. Unless otherwise specified, these values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of ±5% or less of the same unit and/or scale of that being measured, or ±5° when used in conjunction with angles.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

We claim:

1. A fill valve system comprising:
a valve housing,
a float arm,
a float,
a poppet,
a diaphragm, and
a poppet pin;
wherein the float arm is pivotably coupled to the valve housing;
wherein the float is secured to a distal end of the float arm and is configured to rise and fall in response to fluid level changes;
wherein the poppet is disposed within the valve housing and at least partially surrounded by the diaphragm; and
wherein the poppet pin is configured to actuate the poppet in response to movement of the float arm.

2. The fill valve system of claim 1,
wherein the poppet comprises a poppet upper wall and a poppet lower wall defining a poppet cavity; and
wherein a radial bleed hole is formed in the poppet upper wall to enable fluid communication with the poppet cavity.

3. The fill valve system of claim 2,
wherein the diaphragm includes a diaphragm bleed hole configured to allow fluid to pass between the diaphragm and the poppet.

4. The fill valve system of claim 3,
wherein the poppet pin includes a bleed hole seal configured to seal a central bleed hole formed in the diaphragm.

5. The fill valve system of claim 1,
further comprising an arm linkage and a pin arm;
wherein the float arm is coupled to the arm linkage;
wherein the arm linkage is coupled to the pin arm; and
wherein the pin arm is pivotally mounted within the valve housing.

6. The fill valve system of claim 5,
further comprising a poppet pin coupler;
wherein the pin arm is coupled to the poppet pin coupler; and
wherein the poppet pin coupler is configured to transmit motion from the pin arm to the poppet pin.

7. The fill valve system of claim 1,
wherein the diaphragm includes a diaphragm sealing surface configured to engage a valve seat formed in the valve housing.

8. The fill valve system of claim 7,
wherein the poppet includes a poppet sealing protrusion configured to engage an inner wall of a valve outlet below the valve seat.

9. The fill valve system of claim 1,
wherein the diaphragm includes a diaphragm upper wall secured to a diaphragm anchor within the valve housing.

10. The fill valve system of claim 4,
wherein the poppet pin is positioned entirely within the poppet and does not extend through the central bleed hole.

11. The fill valve system of claim 1,
further comprising an adjuster rotator and a float adjuster;
wherein the float arm is coupled to the adjuster rotator;
wherein the adjuster rotator is configured to rotate relative to the valve housing; and
wherein the float adjuster is configured to axially displace along adjuster threads formed on the valve housing.

12. The fill valve system of claim 1,
further comprising an outlet stem;
wherein the outlet stem extends laterally from the valve housing and is in fluid communication with a fluid outlet defined in the valve housing.

13. The fill valve system of claim 1,
wherein the diaphragm, poppet, and poppet pin form a diaphragm assembly configured to regulate fluid flow through the valve housing.

14. The fill valve system of claim 13,
wherein the diaphragm assembly is configured to lift in response to a pressure differential created by unsealing a central bleed hole.

15. The fill valve system of claim 14,
wherein the poppet pin includes one or more protrusions configured to mechanically engage the poppet to assist in lifting the diaphragm assembly.

16. A fill valve system comprising:
an inlet stem,
a valve housing,
a stem coupling, and
a rotatable lock;
wherein the valve housing is rotatably coupled to the inlet stem;
wherein the stem coupling is disposed between the inlet stem and the valve housing; and
wherein the rotatable lock is configured to selectively permit or restrict angular rotation of the valve housing relative to the inlet stem.

17. The fill valve system of claim 16,
wherein the inlet stem includes one or more adjustment protrusions arranged circumferentially along its external surface; and
wherein the stem coupling includes one or more adjustment recesses configured to receive the one or more adjustment protrusions.

18. The fill valve system of claim 17,
wherein engagement between the one or more adjustment protrusions cooperate with the one or more adjustment recesses provides discrete angular indexing positions.

19. The fill valve system of claim 16,
wherein the stem coupling is formed as a split collar configured to expand radially for snap-fit installation over the inlet stem.

20. The fill valve system of claim 16,
wherein the rotatable lock includes a lock protrusion configured to engage a mating feature on the stem coupling to secure a selected orientation.
